(19) United States
(12) Patent Application Publication
(10) Pub. No.: US 2014/0014385 A1
(43) Pub. Date: Jan. 16, 2014

(54) POWER TOOL

(71) Applicant: HITACHI KOKI CO., LTD., Tokyo (JP)

(72) Inventors: Shingo KOSUGI, Hitachinaka (JP); Megumi ISHIKAWA, Hitachinaka (JP); Takuya TERANISHI, Hitachinaka (JP); Keita SAITOU, Hitachinaka (JP); Masanori WATANABE, Hitachinaka (JP)

(73) Assignee: HITACHI KOKI CO., LTD.

(21) Appl. No.: 13/939,810

(22) Filed: Jul. 11, 2013

(30) Foreign Application Priority Data
Jul. 14, 2012 (JP) 2012-158175
Sep. 26, 2012 (JP) 2012-213267
Nov. 25, 2012 (JP) 2012-256999

(51) Int. Cl. B25F 5/02

(52) U.S. Cl. CPC B25F 5/02
USPC 173/217

(57) ABSTRACT

A power tool includes: a handle housing housing a battery and having a first grip part; a motor driven by electric power of the battery; a power transmission system; a main housing housing the handle housing, the motor and the power transmission system and having a second grip part; and a turning mechanism turnably connected at a rear end part of the main housing and a front end part of the handle housing. The power tool is operable at least in a state that the main housing and the handle housing are disposed straight and a state that they are disposed to be folded. In the folded state, the second grip part is positioned in front of the first grip part in an axial direction of the main housing. A trigger and a forward/reverse switch that control the rotation of the motor are disposed on the handle housing side.

### CROSS-REFERENCE TO RELATED APPLICATION

The present application claims priorities from Japanese Patent Application No. 2012-158175 filed on Jul. 14, 2012, Japanese Patent Application No. 2012-213267 filed on Sep. 26, 2012, and Japanese Patent Application No. 2012-256999 filed on Nov. 25, 2012, the contents of which are hereby incorporated by reference into this application.

### TECHNICAL FIELD OF THE INVENTION

The present invention relates to operability improvement, downsizing, and weight reduction of a power tool that uses a storage battery as a drive source. The power tool is comprised of a motor part, a resin-made housing housing a speed reducing mechanism part, etc. that transmits the rotative force generated by the motor part, and a handle turnably provided at the housing.

### BACKGROUND OF THE INVENTION

As a conventional switch structure of a so-called foldable power tool, the technique of Japanese Patent Application Laid-Open Publication No. 2011-73087 (Patent Literature 1) using a switch (SW) turnable about a rotation shaft of a tool retaining part is known. In Patent Literature 1, the tool is comprised of a halved resin-made main housing (front-side housing), which houses a motor part, a speed reducing mechanism part transmitting the rotative force generated by the motor part, etc., and a handle housing (rear-side housing), which is turnably connected and houses a battery in an internal space; and a switch for turning on or off the motor is provided in the main housing side.

FIG. 34 is a vertical cross-sectional view of a straight state of a foldable-type power tool (driver drill) of a conventional technique. The power tool 201 is configured such that a main housing 202 and a handle housing 203 can be turned about a turning shaft 210. The main housing 202 is a main housing for housing a motor 204 and a power transmission system and houses: the motor 204; a speed reducing mechanism 218 for reducing the speed of the rotation of the motor 204; and a clutch mechanism 220 for transmitting the output of the speed reducing mechanism 218 to an output shaft 226 and also shutting off motive power when predetermined tightening torque or more is obtained. The speed reducing mechanism 218 and the clutch mechanism 220 serve as a power transmission system, which transmits the rotative force of the motor 204 to the output shaft 226.

A switch 206, which turns on or off the rotation of the motor 204, is provided in the space which is in the rear side of the motor 204 of the main housing 202 and in the front side of the turning shaft 210. The switch 206 is connected to a lever part 207, which is moved in the circumferential direction of the main housing 202 having a cylindrical shape. When the lever part 207 is moved in a first direction of the circumferential direction, the motor 204 is rotated in a forward direction (direction in which a screw is tightened with a tip tool (bit)); and, when the lever part 207 is moved in a second direction, the motor 204 is rotated in a reverse direction (direction in which a screw is loosened with the tip tool). The switch 206 sets either ON or OFF of the motor 204 and causes the motor 204 to rotate at a determined speed by obtaining the ON state, but is not capable of adjusting the speed of the rotation of the motor 204.

The handle housing 203 is a housing, which houses a battery 230 and serves as a grip part to be grasped (held) by an operator; and the handle housing is formed in a substantially cylindrical shape having an opening 203c at a rear end and is manufactured by a left-right division style by integral molding of a polymer resin product such as plastic. The main housing 202 and the handle housing 203 are coupled to each other so as to be turnable about the turning shaft 210 by about 70 degrees. The battery 230 housed in the handle housing 203 is formed by a so-called battery pack method by which it is attachable/detachable through the opening 203c, and a latch part 231 is provided in the rear side thereof. The rear surface of the battery 230 forms part of an outer edge part of the handle housing 203, and a metal-made connector 232 is provided at a substantially rectangular corner part at the front end thereof.

A terminal base 211 is provided in the handle housing 203, and a plurality of metal-made terminals 212 are fixed thereto. When the connector 232 is brought into contact with the plurality of terminals 212 in the power tool 201 side by attaching the battery 230 to the interior of the handle housing 203, a state that electric power can be supplied from the battery 230 to the motor 204 is obtained. The vicinity of the lower side of the turning shaft 210 serves as the space for allowing extension of a lead wire 209a, which is an power supply line from the terminal 212 to the motor 204, and a lead wire 209b, which supplies electric power to a LED 214 for irradiating the vicinity of the tip tool; and a cover 215 is provided for covering the space. The cover 215 is a plate-like member, which is fixed to the main housing 202 side by a turning shaft 216. In the front side of the terminal base 211 of the handle housing 203, housing space 217 for housing the cover 215 when the housing is folded is formed.

FIG. 35 is a vertical cross-sectional view of a folded state (gun-type shape or pistol shape) of the power tool 201 of the conventional technique and shows a state in which the handle housing 203 has been turned about the turning shaft 210 relatively by about 70 degrees with respect to the main housing 202 from the state of FIG. 14. As is understood from this drawing, when the handle housing 203 is turned, the interval between the turning shaft 216 and the terminal base 211 is narrowed; therefore, the cover 215 is not required in terms of function, and the cover 215 is therefore configured to be housed in the housing space 217 so as not to affect folding movement. By virtue of such a structure, the foldable-type power tool of the conventional technique can be used in the two modes in which the main body of the tool is straight or gun type.

### SUMMARY OF THE INVENTION

In the power tool of the conventional technique, the lever part 207, which controls supply/stoppage of electric power to the motor 204, is disposed on the main housing 202 side, and the switch 206, which controls supply/stoppage of electric power to the motor 204, is also provided on the main housing 202 side. Therefore, in the aspect as described in FIG. 35, operating the lever part 207 with one hand while holding the handle housing 203 has not been very easy. Moreover, when a turning mechanism part disposed between the main housing 202 and the handle side (handle housing 203) is turned to change the shape from the straight shape to the gun-type shape, the cover 215, which is provided with a supporting point in the main housing 202 side, enters the inside of the handle housing 203.

In the power tool as described above, when the switch 206 is provided in the handle housing 203 side, the switch has to be disposed in the vicinity of the position (housing space 217) to which the cover 215 enters in the gun-type shape; therefore, the switch and the cover 215 interfere with each other. In order to prevent the interference, the handle housing 203 has to be extended in the central-axis direction (=front-rear direction), the size of the power tool is increased, and portability is lost. Furthermore, when used in the folded state, the both lateral surfaces of the main housing are held with the thumb and the forefinger, and a switch operation is carried out with the right hand; therefore, there has been a risk that the holding state of the tool main body becomes unstable during the operation of the switch, and the stability of the output shaft may be reduced.

It is a preferred aim of the present invention to provide a foldable-type power tool having an easy-to-use switch mechanism in which the position of a switch is moved to a handle housing side.

It is another object of the present invention to provide a power tool which is a foldable type and is configured to be able to firmly retain a housing main body so that an output shaft is stabled and operations are enabled.

It is another preferred aim of the present invention to provide a power tool which has reduced the risk of squeezing of a finger(s) in the vicinity of a hinge of a main housing and a handle housing upon folding.

It is another preferred aim of the present invention to provide a power tool which is a foldable type and is configured to be able to firmly retain the housing main body so as to stabilize the output shaft and enable operations.

It is a still another preferred aim of the present invention to provide a power tool which has reduced the risk of squeezing of a finger(s) in the vicinity of the hinge of the main housing and the handle housing.

According to one feature of the present invention, a power tool has: a handle housing that houses a battery and has a first grip part; a motor that is driven by electric power of the battery; an output shaft to which a tip tool is attached; a power transmission system that transmits rotative force of the motor to the output shaft; a main housing that houses the motor and the power transmission system and has a second grip part; and a turning mechanism that is turnably connected at a rear end part of the main housing and a front end part of the handle housing; the power tool operable in at least a state that the main housing and the handle housing are disposed straight and a state that the main housing and the handle housing are disposed to be folded; in which, in the state that the handle housing is folded, the second grip part is positioned in front of the first grip part in an axial direction of the main housing. A switch and a trigger that control rotation of the motor are provided in the rear of the turning mechanism of the handle housing.

According to another feature of the present invention, the first and second grip parts are formed of a material having higher elasticity than that of the handle housing and the main housing, and the second grip part is provided on each of left-right lateral surfaces of the main housing. The second grip part forms a curved surface serving as a surface curved in an opposite direction of an outer peripheral surface of the main housing having a substantially cylindrical shape. The first and second grip parts are manufactured by two-layer molding with the handle housing and the main housing. An upper end surface of the handle housing has a first recessed part having a length longer than the width of two fingers. In the upper end surface of the handle housing, a second recessed part is formed in the vicinity of the rear of the trigger.

In this manner, according to the present invention, in the state in which the handle housing is folded, the second grip part is serially aligned in front of a part of the first grip part in the axial direction of the main housing. Therefore, in the state in which the operator is holding the handle housing, the second grip part of the main housing can be held from both left-right side in a manner that the thumb and the forefinger are stretched toward the main housing side, the stability of the output shaft can be maintained while firmly holding the main body of the power tool, and highly precise reliable operations can be carried out.

Moreover, in the immediately rear of the turning mechanism of the handle housing, the switch and the trigger that control the rotation of the motor are provided. Therefore, even when the housing is folded to form the gun type to carry out an operation, the trigger can be disposed at an easy-to-use position, and the main housing can be configured to be compact.

Furthermore, the first and second grip parts are formed of a material having higher elasticity than that of the handle housing and the main housing. Therefore, a power tool that does not easily cause slippage which leads to reduction of fatigue of the holding fingers can be achieved.

### BRIEF DESCRIPTIONS OF THE DRAWINGS

FIG. 1 is a lateral view showing an appearance of a case in which a power tool 1 according to a first embodiment of the present invention is straight;

FIG. 2 is a partial cross-sectional view showing an internal structure of the power tool 1 according to the embodiment of the present invention;

FIG. 3A is a diagram showing an operation state in the case in which the power tool 1 according to the embodiment of the present invention is straight, showing a first holding state;

FIG. 3B is a diagram showing an operation state in the case in which the power tool 1 according to the embodiment of the present invention is straight, showing a second holding state;

FIG. 4 is a lateral view showing an operation state in which the power tool 1 according to the embodiment of the present invention is folded;

FIG. 5 is a top view showing the operation state in which the power tool 1 according to the embodiment of the present invention is folded;

FIG. 6A is a diagram showing an A-A part of an outer shape of a main housing 10 of FIG. 1;

FIG. 6B is a cross-sectional view showing a B-B part of the outer shape of the main housing 10 of FIG. 1;

FIG. 7 is a diagram for explaining the shape of a handle housing 20 of FIG. 1;

FIG. 8 is a lateral view showing another grasping (holding) state of the case in which the power tool 1 according to the embodiment of the present invention is folded;

FIG. 9 is a partial perspective view (straight state) for explaining the shape in the vicinity of a turning mechanism of the main housing 10 and the handle housing 20 of FIG. 1;

FIG. 10 is a partial perspective view (folded state) for explaining the shape in the vicinity of the turning mechanism of the main housing 10 and the handle housing 20 of FIG. 1;

FIG. 11 is a lateral view showing an appearance of a straight state of the power tool 1 according to a second embodiment of the present invention;

FIG. 12 is a lateral view showing an appearance in a folded state of the power tool 1 according to the second embodiment of the present invention;

FIG. 13 is a diagram showing a hand of an operator who holds the power tool 1 by grasping it;

FIG. 14 is a diagram showing an overall configuration of a power tool (impact driver) according to a third embodiment of the present invention and also is a diagram (partially cross-sectional view) showing a state in which a right side of housings is detached (straight state);

FIG. 15 is a vertical cross-sectional view showing an overall configuration of the power tool (impact driver) and also is a diagram (partially cross-sectional view) showing a state in which the right piece side of the housings is detached (folded state);

FIG. 16 is a lateral view showing a mode of the straight state of the power tool according to the third embodiment of the present invention;

FIG. 17 is a lateral view showing a mode of the folded state of the power tool according to the third embodiment of the present invention;

FIG. 18 is a diagram showing an overall configuration of a power tool (driver drill) according to a fourth embodiment of the present invention and is a diagram (partially cross-sectional view) showing a state in which a right piece side of a housing is detached (straight state);

FIG. 19 is a diagram showing an overall configuration of the power tool (driver drill) according to the fourth embodiment of the present invention and is a diagram (partially cross-sectional view) showing a state in which the right piece side of the housing is detached (folded state);

FIG. 20 is a partially enlarged view of a switch part of a power tool according to a fifth embodiment of the present invention;

FIG. 21 is a partially enlarged view of a switch part of a power tool according to a sixth embodiment of the present invention;

FIG. 22 is a vertical cross-sectional view showing an overall structure of a foldable power tool 1 (impact driver) according to a seventh embodiment of the present invention, showing a straight state;

FIG. 23 is a vertical cross-sectional view showing an overall structure of the foldable power tool 1 (impact driver) according to the seventh embodiment of the present invention, showing a folded state;

FIG. 24 is a cross-sectional view of the A-A part of FIG. 23;

FIG. 25 is a lateral view for explaining a usage state of the straight state of the power tool according to the seventh embodiment of the present invention;

FIG. 26 is a lateral view for explaining a usage state of a straight state of the power tool according to the seventh embodiment of the present invention, showing a state of operation in which a main body is directed downward;

FIG. 27 is a lateral view for explaining a usage state of a folded state of the power tool according to the embodiment of the present invention;

FIG. 28 is a vertical cross-sectional view showing an overall structure of a foldable power tool 51 (driver drill) according to an eighth embodiment of the present invention and is a diagram showing a straight state;

FIG. 29 is a vertical cross-sectional view showing an overall structure of the foldable power tool 51 (driver drill) according to the eighth embodiment of the present invention and is a diagram showing a folded state;

FIG. 30 is a partial cross-sectional view of a foldable power tool according to a ninth embodiment of the present invention;

FIG. 31 is a partial cross-sectional view of a foldable power tool according to a tenth embodiment of the present invention;

FIG. 32 is a partial cross-sectional view of a foldable power tool according to an eleventh embodiment of the present invention;

FIG. 33 is a partial cross-sectional view of a foldable power tool according to a twelfth embodiment of the present invention;

FIG. 34 is a vertical cross sectional view showing an overall configuration of a power tool 201 (driver drill) of a conventional technique (straight state); and

FIG. 35 is a vertical cross-sectional view showing an overall configuration of the power tool 201 (driver drill) of the conventional technique (folded state).

### DESCRIPTIONS OF THE PREFERRED EMBODIMENTS

### First Embodiment

Hereinafter, an embodiment of the present invention will be described based on the drawings. In the drawings described below, the same parts are denoted by the same symbols, and repetitive explanations thereof will be omitted.

A power tool 1 uses a chargeable and attachable/detachable battery pack 60 as an electric power source, uses an unillustrated motor as a drive source to apply rotative force and striking force to an output shaft via a power transmission system, and carries out operations such as screw tightening and bolt tightening by transmitting the rotative force or striking force to a tip tool such as a driver bit 58 retained by an attachment hole covered with a sleeve 57. A housing of the power tool 1 consists of a main housing (front housing) 10 and a handle housing (rear housing) 20. The main housing 10 is formed by integral molding of a polymer resin such as plastic so as to be dividable into two to the left and the right, and the left-right parts are fixed by unillustrated screws. The handle housing 20 is formed to have a cylindrical shape having an opening 20c at a rear end and is manufactured by a left-right division style by integral molding of a polymer resin such as plastic.

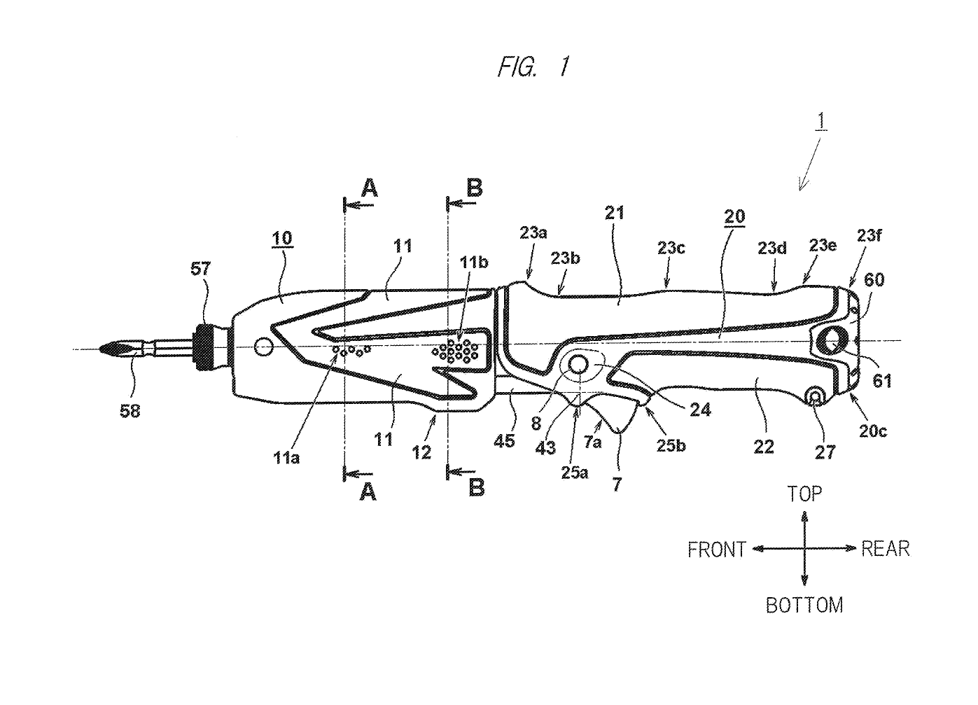

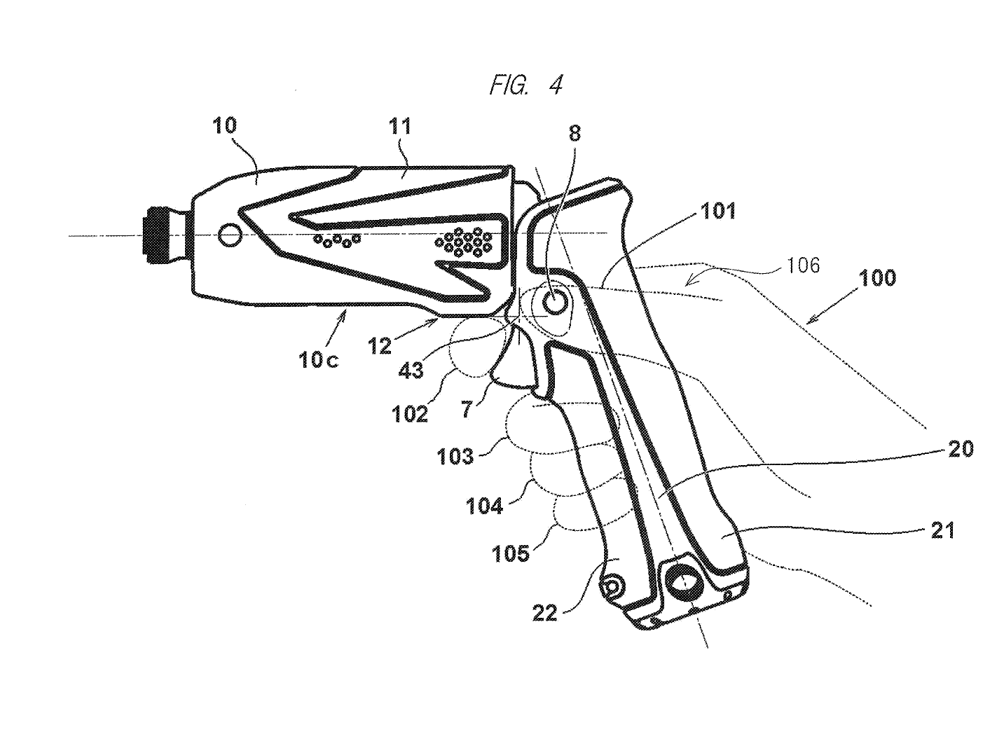

The main housing 10 and the handle housing 20 are coupled to each other by a turning mechanism having an unillustrated turning shaft in the vicinity of the center of the front-rear direction and is turnable about the turning shaft by about 70 degrees. The plane that turns is the plane including the front-rear and top-bottom directions viewed in FIG. 1 (the plane same as the paper surface), and the shape of a so-called straight type in which the main housing 10 and the handle housing 20 are coaxially aligned like FIG. 1 can be changed into the shape turned in the manner as shown in later-described FIG. 4, i.e., into the shape of a so-called gun type. Upon carrying out operation, an operator can set the shape of the straight type or the gun type depending on the location or target of the operation.

The power tool 1 of FIG. 1 can be achieved as a so-called driver drill, an impact driver, or another power tool of a cordless type by using a publicly-known mechanism as the power transmission system. In the present embodiment, the power tool is achieved as an impact driver incorporating an impact mechanism (striking mechanism). The motor, which will be described later, is housed in the main housing 10, and a rotation shaft thereof is connected to the power transmission system for rotating the tip tool. The battery pack 60 has a substantially cylindrical chassis, which can be attached to and detached from internal space from the opening 20c at the end of the handle housing 20, and is an electric power source of a so-called cassette type, which is easily replaceable. Unillustrated hooking parts are formed at two locations on the chassis of the battery pack 60, and the battery pack 60 is retained when they are engaged with recessed parts (not illustrated) formed on an inner wall of the handle housing 20.

To detach the battery pack 60, the battery pack 60 is pulled out from the opening 20c while pushing latch parts 61 provided at two locations on the left and the right. The shape of the rear end of the battery pack 60 is formed so as to cover the opening 20c of the handle housing 20, and the rear surface of the battery pack 60 forms part of an outer edge part of the handle housing 20. A plurality of lithium-ion cells of, for example, 18650 or 14500 are housed in the battery pack 60; however, the sizes, types, numbers, etc. of the batteries may be optionally set.

In the space of the part that is in the handle housing 20 and is adjacent to the turning mechanism, a trigger 7, which operates a switch (main switch) for controlling supply/stoppage of electric power to the motor, and a forward/reverse switching lever 8 for switching the rotation direction of the motor are housed. In the present embodiment, the main switch is a so-called variable resistance switch in which the resistance value thereof is varied depending on the operation amount of the trigger 7 and is configured so that the rotation speed of the motor is varied depending on the operation amount of the trigger 7. The trigger 7 has a trigger body part 7a having a width around which a finger can be hooked, and the rear end of the trigger 7 is configured to be swingable substantially in the top-bottom direction when the front side thereof swings (turns) about an axis point (swinging shaft 43) by a predetermined angle.

The forward/reverse switching lever 8 is provided substantially above the swinging shaft 43 of the trigger 7. The forward/reverse switching lever 8 is connected to a switch for switching the rotation direction of the motor to a “forward rotation direction (tightening direction)” and a “reverse rotation direction (loosening direction)”. The forward/reverse switching lever 8 can be operated by sliding in the left-right direction. Meanwhile, it is preferred to achieve a mechanical or electrical lock mechanism by providing not only lever positions at the two locations corresponding to a forward-rotation-direction position and a reverse-rotation-direction position but also providing a lock position between the two locations so that, at the lock position, the trigger 7 is locked to be mechanically not movable or the motor is not electrically turned on even when the trigger 7 is pulled. A concave part 24, which is hollowed from an outer part of the handle housing 20 toward the inner side, is provided in the periphery of the forward/reverse switching lever 8 to configure so that forward/reverse switching lever 8 after operation is not projected from the outer part of the handle housing 20 to the outer side. A specific configuration of the concave part 24 will be described later.

The handle housing 20 serves as a part that is mainly held by the operator and has a function of a base member which forms a first grip part. Therefore, the handle housing has a shape that fits a hand when being held by the operator, and, in the upper side of the handle housing, two gently recessed parts (concaves) 23b and 23d are formed from a front end 23a to a rear step part 23e. When the directions of the handle housing 20 are mentioned in the present specification, they are viewed based on the case in which the power tool 1 is in the straight shape as shown in FIG. 1 unless otherwise stated (the same applies hereinafter). Explanations will be given on the assumption that the “grip part” mentioned in the present specification refers to a part provided with a soft member such as an elastic body on the housing.

The part between the recessed part 23b and the recessed part 23d is configured so that the boundary between the front/rear concaves can be found out by a flexion point 23c. As a result of providing the flexion point 23c, when the operator holds the handle housing 20, by which part of the grip part he/she is holding can be found out by tactile sensation. A lower part of web spaces of fingers on which the largest force acts can be guided by the first recessed part 23b; therefore, the grip part having good workability can be provided. In this case, as the shape of the handle housing 20, the two gently recessed parts (concaves) 23b and 23d are formed, and elastic bodies 21 and 22 serving as the first grip part are formed.

The elastic bodies 21 and 22 are constituent materials having higher elasticity than those of the constituent material (plastic) of the handle housing 20 and are formed as thin surface layers of a resin having high elasticity on a lower layer serving as the constituent material of the handle housing 20 by using, for example, techniques of two-layer molding. Since publicly known techniques can be used as the manufacturing technique of the two-layer molding, detailed explanations thereof will be omitted. The part on which the elastic body 22 formed at a position separated from the elastic body 21 also forms part of the first grip part. The elastic body 22 also forms two recessed parts and a flexion point from the vicinity of the front end thereof to the vicinity of the rear end thereof, and the detailed shapes thereof will be described later. The first grip part of the present embodiment is formed by the elastic bodies 21 and 22, which are disposed to be separated from each other; however, the first grip part is not limited to this shape, but may be configured to have a shape coupling the elastic bodies 21 and 22 or configured so as to be divided into three or more and dispersedly disposed.

The main housing 10 is subsidiarily held by the operator in some cases, and a second grip part is therefore formed also in the main housing 10 side. The second grip part is a part in which an elastic body 11 is formed. The elastic body 11 is also a constituent material having higher elasticity than that of the constituent material (plastic) of the main housing 10 and is formed as a thin surface layer of a resin of a resin having high elasticity on a lower layer serving as the constituent material of the main housing 10 by using, for example, techniques of two-layer molding. Moreover, the shape of a particular area of the elastic body 11 is arranged and configured so that force easily acts on the main housing 10 via a holding finger(s) when held by the operator.

Non-slip treated parts 11a and 11b are formed in particular parts of the elastic body 11. The non-slip treated parts 11a and 11b are formed at the same positions also on the right-side lateral surface of the main housing 10. The non-slip treated parts 11a and 11b are formed by, for example, a plurality of small recessed parts formed on the elastic body 11. The non-slip treated parts are not limited only to recessed parts but also may be formed by convex parts, grooves, steps, etc. since an object thereof is to prevent slipping. Furthermore, only the non-slip treated parts 11a and 11b may be formed of a further another material (third material). The elastic body 11 serving as the second grip part is similarly formed also on the right-side lateral surface (not illustrated) as well as the illustrated left-side lateral surface and is bilaterally symmetrical and coupled on the upper side.

A cover 45 is disposed on the lower side of the turning center by which the main housing 10 and the handle housing 20 are folded (the side in which a narrow angle is formed). The cover 45 is a plate-like member. When the power tool 1 is used in the mode shown in FIG. 1, in other words, in the straight shape, the cover plays a role as an outer frame part which closes the space in the vicinity of the part of the turning mechanism between the main housing 10 and the handle housing 20.

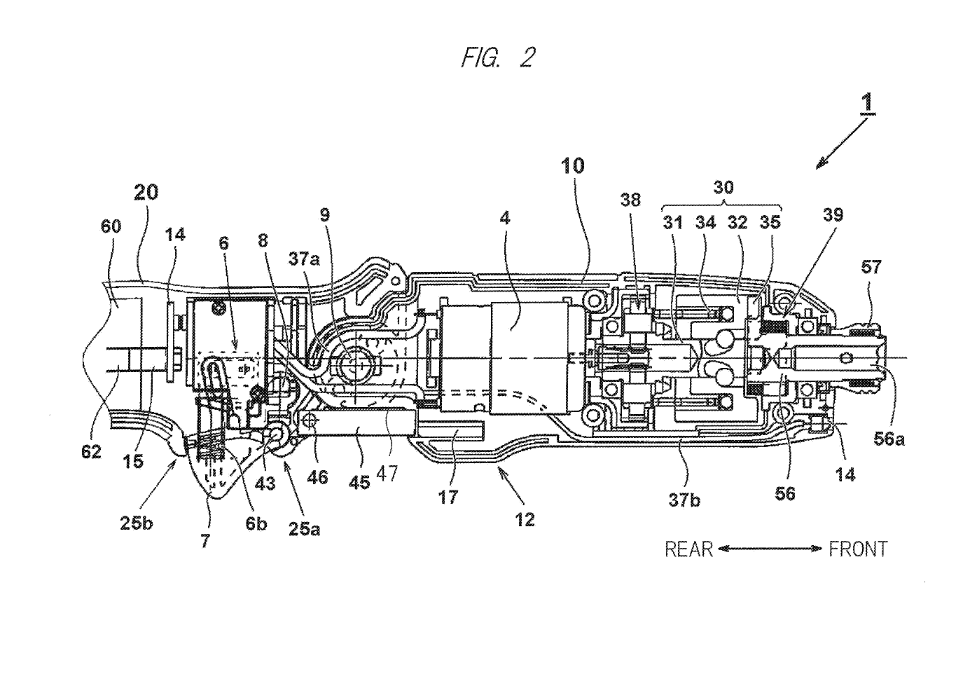

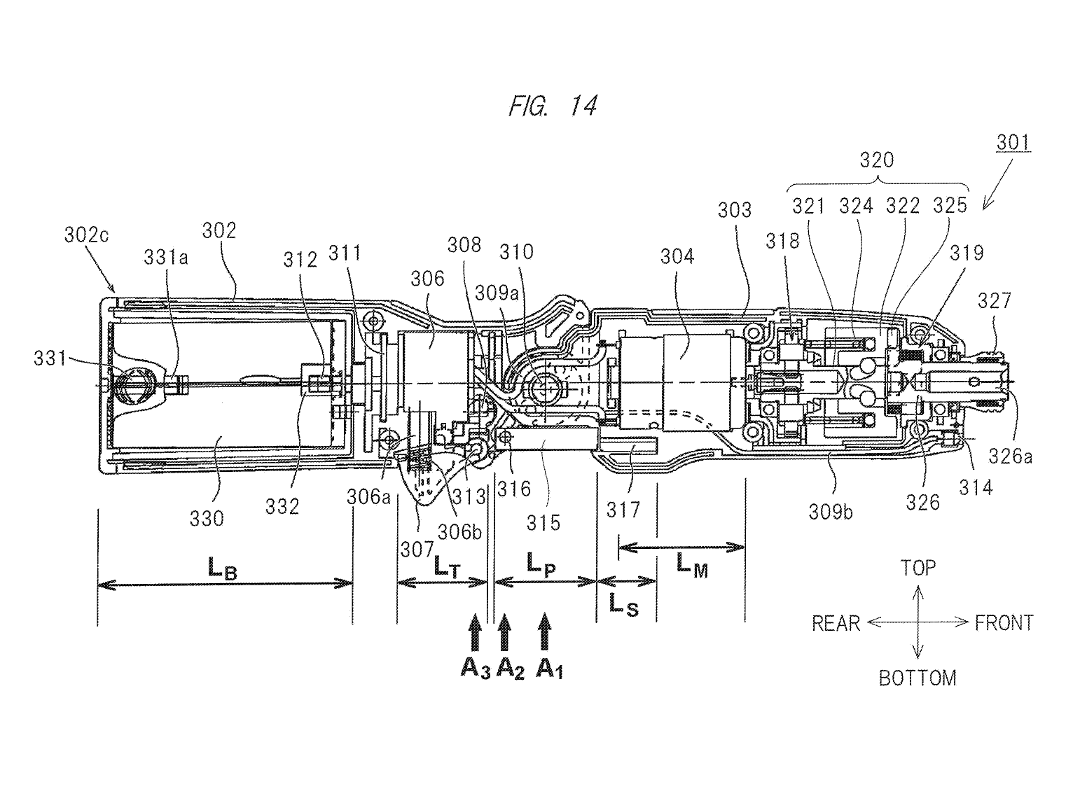

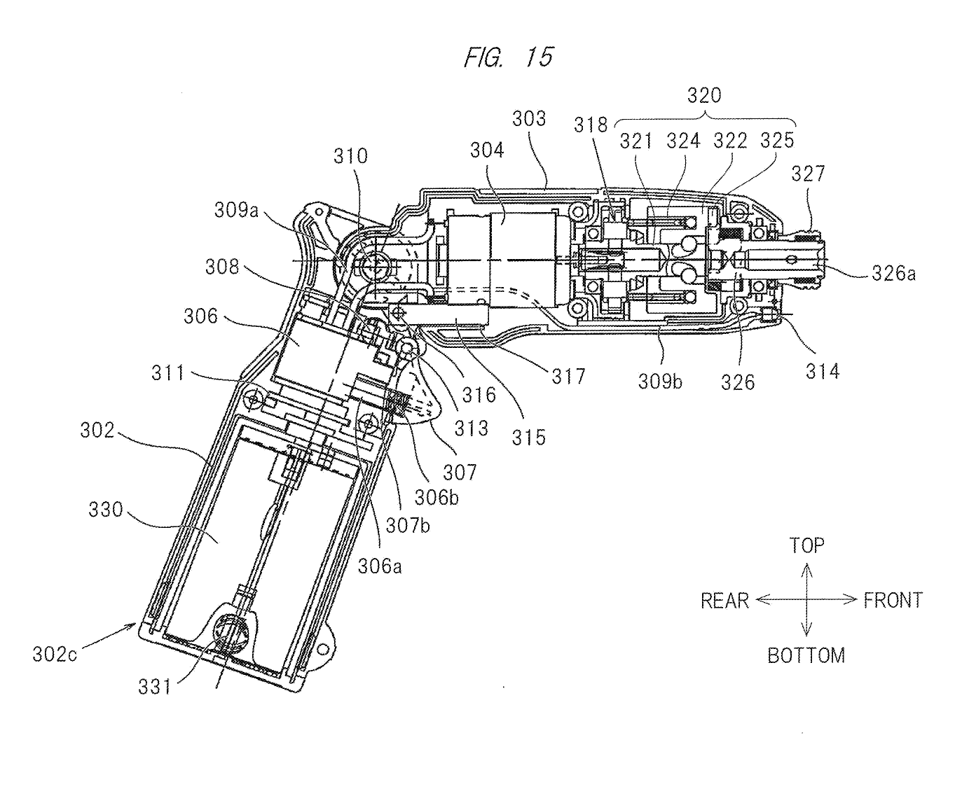

Next, the internal structure of the power tool 1 will be explained by using a partial cross-sectional view of FIG. 2. FIG. 2 is a diagram showing a state in which the right-side housings of the main housing 10 and the handle housing 20 are detached. In the internal structure, for the sake of convenience of explanations, the part of the power transmission system (38, 30, 39) is shown by a cross-sectional view. In the present embodiment, the switch 6 and the trigger 7 are disposed on the handle housing 20 side, different from the conventional foldable-type power tool shown in FIGS. 14 and 15. The motor 4 is a brushed DC motor used as a drive source, which rotates an unillustrated tip tool, and is housed in the rear side of the main housing 10. In the present embodiment, the battery pack 60 is used as an electric power source for driving the motor 4. The rotation shaft of the motor 4 is connected to the power transmission system for rotating a tip tool.

In the present embodiment, the power transmission system is comprised of a speed reducing mechanism 38, which uses planetary wheels, and the striking mechanism 30 having a hammer 32 and an anvil 35, and is serially disposed having the same axis as the motor 4. The speed reducing mechanism 38 has a sun gear attached to the rotation shaft of the motor 4, a plurality of planetary gears, and a fixed-type ring gear on the outer peripheral side of the planetary gears. In the speed reducing mechanism 38, a planetary carrier fixing a rotation shaft of the plurality of planetary gears is rotated. A widely used publicly-known striking mechanism (impact mechanism) can be used as the striking mechanism 30. The striking mechanism 30 is comprised of: a spindle 31, which is connected to the planetary carrier; a hammer 32, which is movable in an axial direction; a spring 34, which biases the hammer 32; cam grooves; balls; etc. A spindle lock mechanism 39, which prevents relative rotation of an output shaft 56 with respect to the main housing 10 when the motor 4 is stopped, is provided between the striking mechanism 30 and the sleeve 57. The spindle lock mechanism 39 is a lock mechanism for carrying out hand tightening by rotating the power tool 1 as if the power tool is a driver after rotation of the motor 4 is stopped. Since a specific structure of the spindle lock mechanism 39 is publicly known, the explanation thereof is omitted herein.

A connector (terminal) 62 is provided at a substantially rectangular corner part at the front end of the battery pack 60. On the other hand, a plurality of metal-made terminals 15 are fixed to a terminal base 14 of the handle housing 20. When the battery pack 60 is attached to the interior of the handle housing 20, the connector 62 is brought into contact with the plurality of terminals 15 on the power tool 1 side. As a result, a state in which electric power from the battery pack 60 can be supplied to the motor 4 is obtained. The switch (main switch) for controlling supply/stoppage of electric power to the motor 4, and a forward/reverse switch for switching the rotation direction of the motor 4 are housed in the space that is in the handle housing 20 and between the battery pack 60 and a turning shaft 9.

In the present embodiment, the switch 6 is a so-called variable resistance switch in which the resistance value thereof is varied depending on the operation amount of the trigger 7 and is configured so that the rotation speed of the motor 4 is varied depending on the operation amount of the trigger 7. The front side of the trigger 7 is configured to be swayed (turned) only by a predetermined angle about the swinging shaft (swing supporting point) 43 so that the rear part of the trigger 7 is practically movable in the top-bottom direction. A compressed spring 6b is provided between the trigger 7 and the switch 6; and, when the trigger 7 is set free, the trigger 7 is moved in the direction in which the switch 6 is released. In the present embodiment, the swinging shaft 43 is provided on the front side of the trigger 7; therefore, the operator who holds the handle housing 20, which forms the first grip part, can easily hold the trigger 7, and the power tool 1 having an easy-to-use switch mechanism is achieved.

The forward/reverse switching lever 8 is provided in the space which is on the front side of the switch 6 and between the switch 6 and the turning shaft 9. The cover 45 is disposed in the vicinity of the turning shaft 9 and in the side toward which the main housing 10 and the handle housing 20 are folded (the side in which a narrow angle is formed). In a way opposite to that of the power tool shown in FIGS. 14 and 15, the cover 45 is retained by a turning shaft (supporting point) 46, which is provided on the handle housing 20 side. As to a role of the cover 45, the cover 45 plays a role as an outer frame part which covers the space in the vicinity of the part of the turning mechanism between the main housing 10 and the handle housing 20 when the power tool 1 is used in the mode shown in FIG. 1, i.e., the straight form, and the cover is a plate like member.

Particularly, in the power tool in which the battery pack 60 is disposed in the handle housing 20, a lead wire 37a, which supplies electric power to the motor 4, and a lead wire 37b, which supplies electric power to an LED 14, have to be disposed in the vicinity of the turning shaft 9; therefore, the power tool has the structure which is provided with the space for allowing their extension. Note that, since the cross section of the cover 45 perpendicular to the axial direction thereof includes an opening having an upright U-shape, the height of the cover 45 (lateral surface of the cover 45) and the height of a housing space 47 (substantially equal to the cross section of the center part of the cover 45) do not match with each other when viewed in FIG. 2.

As is understood in FIG. 2, the present embodiment is configured so that the cover 45 is axially supported on the handle housing 20 side, the switch 6 and the trigger 7 can be therefore easily disposed in the handle housing 20. The turning shaft 9 of the turning mechanism of the housing, the turning shaft 46 of the cover 45, and the swinging shaft 43 of the trigger 7 are disposed so as to be extended in the left-right direction and are parallel to one another. The turning shaft 9, the turning shaft 46, and the swinging shaft 43 are sequentially disposed from the front to the rear. This means that the turning shaft 46 and the swinging shaft 43 are disposed in the rear of the turning shaft 9, in other words, they are disposed in the handle housing 20; therefore, the internal structure of the main housing 10 can be simplified, and the assembling performance thereof can be improved.

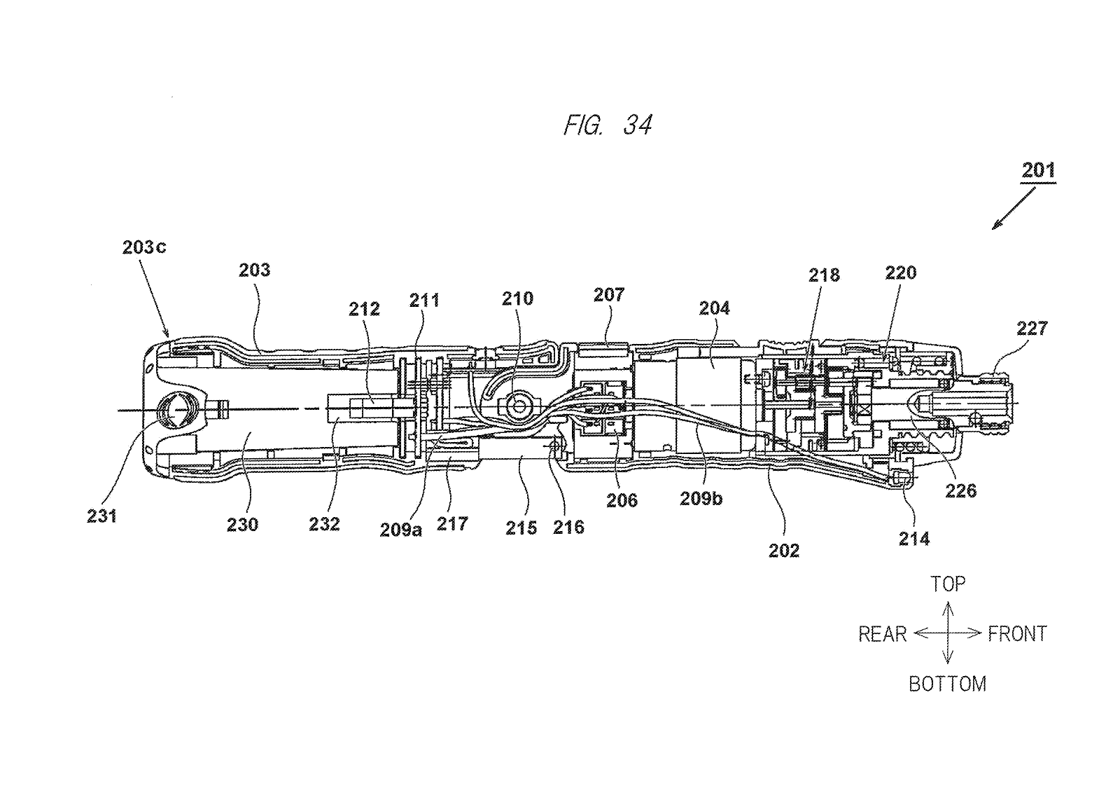

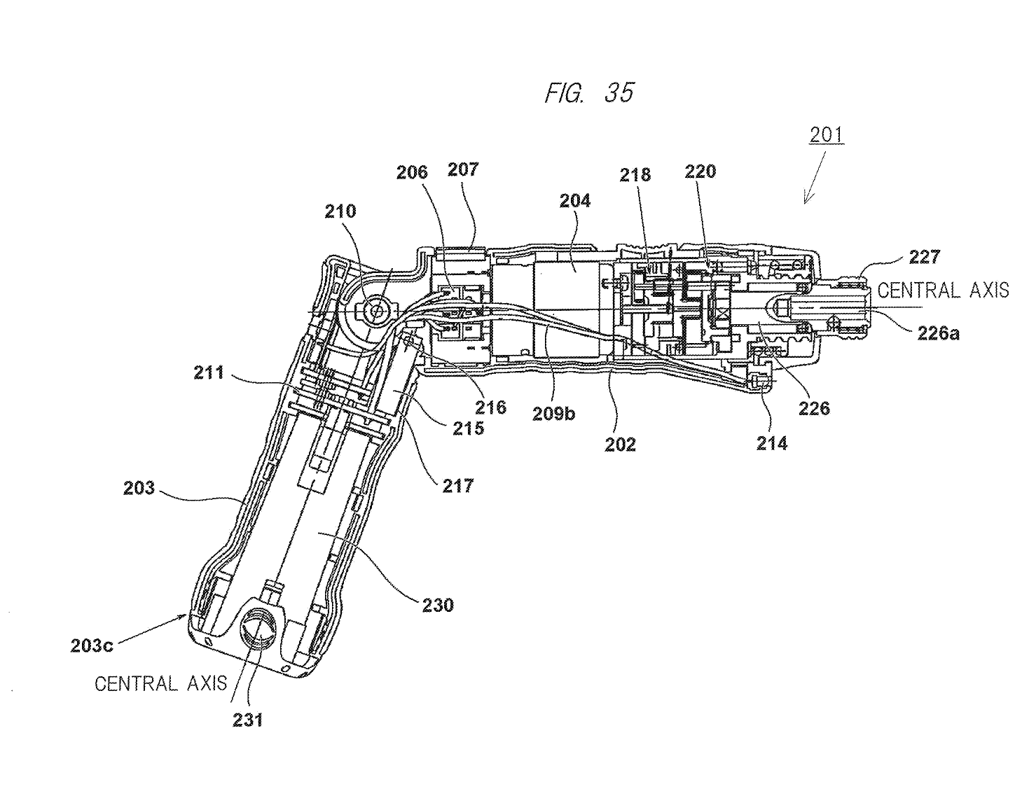

Furthermore, the main housing 10 is not required to house the switch mechanism between the motor 4 and the turning shaft 9 different from the conventional technique shown in FIGS. 34 and 35, and the axial-direction length of the main housing 10 can be therefore shorter by the length of the switch mechanism. Furthermore, a protruding part 12 is provided below the motor 4 of the main housing 10; therefore, this is suitable as a guide of the finger(s) of the operator when folded and used (details will be described later) and is optimal for ensuring housing space 17.

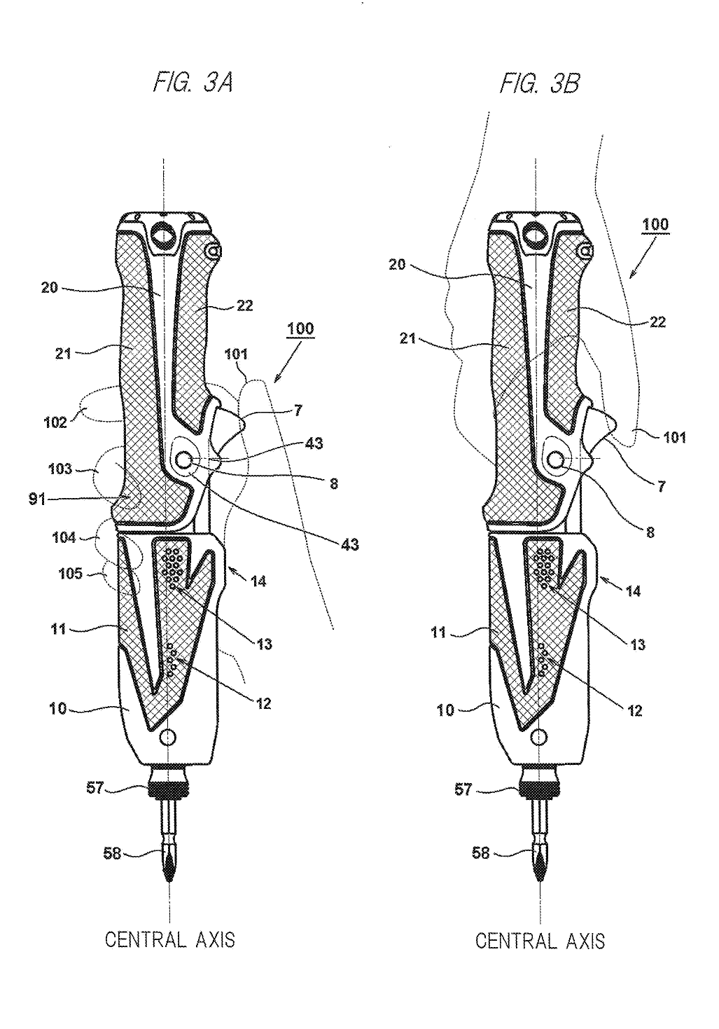

Next, an operation state in the case in which the power tool 1 according to the embodiment of the present invention is straight will be explained with reference to FIG. 3. In the present embodiment, the swinging shaft 43 is provided on the front side of the trigger 7; therefore, the operator who is holding the handle housing 20, which also serves as the grip part, can easily hold the trigger 7, and the power tool 1 having the easy-to-use switch mechanism can be achieved.

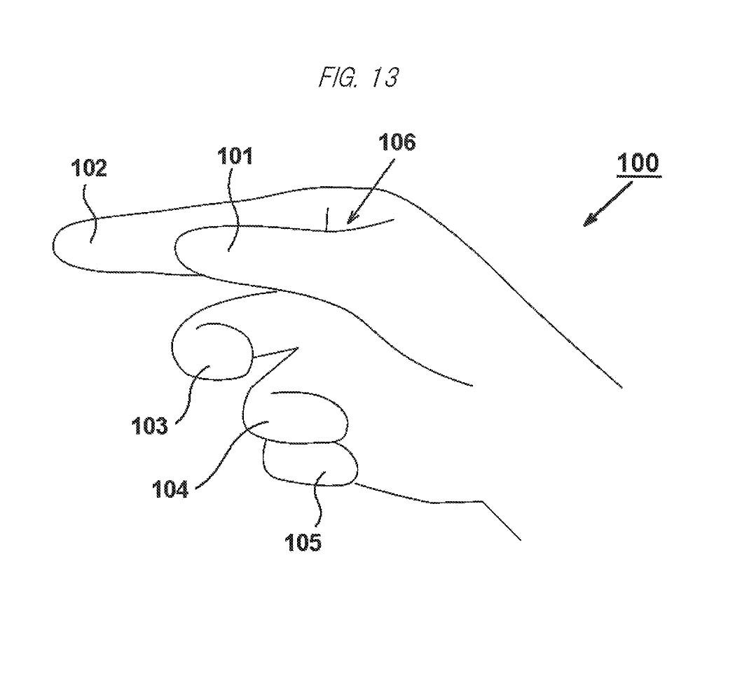

FIG. 3A is a lateral view showing a first gripping (grasping) state. Normally, the operator carries out operation while gripping the power tool with his/her dominant hand (for example, the right hand). The role of the right hand 100 of the operator will be explained with reference to FIG. 13. As shown in FIG. 13, the switch of the power tool 1 is often operated by using the forefinger 102 and the middle finger 103, and the thumb 101, the ring finger 104, and the little finger 105 are often used for holding the grip part. In order to grip the grip part, the power tool 1 is firmly retained by using a part under finger web 106.

Again returning to FIG. 3, in the manner of gripping shown in FIG. 3A, the trigger 7 is operated by the thumb, and the handle housing 20 is held by the forefinger 102 and the middle finger 103. On the other hand, the ring finger 104 and the little finger 105 hold the main housing 10 side. In this case, the part of the handle housing which is held by the middle finger 103 (the vicinity of an arrow 91) is the first grip part (the elastic body 21) to which rubber is pasted as shown by lattice lines in the drawings; therefore, it is very easy to grip, and the trigger 7, which is operated by the thumb, is also easy to use.

The upper-side coupled part of the elastic body 11 is gripped by the vicinities of the distal ends of the ring finger 104 and the little finger 105; therefore, gripping it is comfortable and it facilitates operation. In this way of gripping, the forward/reverse switching lever 8 can be easily operated by moving the thumb 101 or the forefinger 102, and there is no need to largely separate the hand from the main housing 10 or the handle housing 20.

FIG. 3B shows a situation in which operation is carried out while only the handle housing 20 side is being gripped by one hand. This usage method is the way of gripping which is suitable for the operation of tightening a screw at a deep part of a narrow place. In this way of holding, the trigger 7 is operated by the thumb 101. In this way of holding, the elastic bodies 21 and 22, which form the first grip part, are mainly held; therefore, holding the tool is comfortable and it facilitates the operation. Also in this way of holding, the forward/reverse switching lever 8 can be easily operated by moving the thumb 101 or the forefinger 102, and there is no need to detach the hand from the handle housing 20; therefore, an easy-to-use layout of the trigger 7 and the forward/reverse switching lever 8 can be achieved.

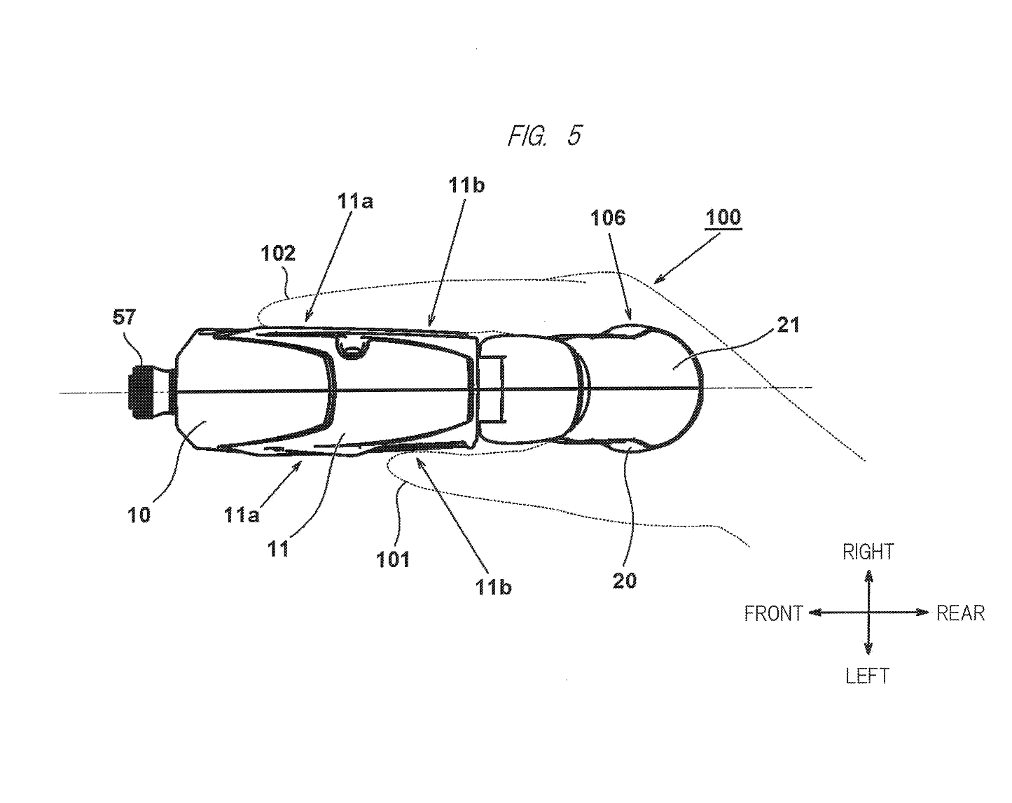

Next, an operation state of a case in which the power tool 1 according to the embodiment of the present invention is folded will be described with reference to FIGS. 4 and 5. Upon folding, the central axes of the main housing 10 and the handle housing 20 are disposed to be extended in mutually intersecting directions, thereby achieving a so-called gun type (pistol shape). In the present embodiment, in the straight state, the turning shaft 9 (see FIG. 2) is provided in the axial-direction front side of the trigger 7, and the elastic body 21 constituting the first grip part is disposed to the vicinity of the upper end of the handle housing 20 in the folded state; therefore, operation can be carried out while gripping the handle housing 20, which also serves as the grip part, by the right hand 100 of the operator as shown by dotted lines in FIG. 4.

Moreover, since the protruding part 12 protruding to the lower side of the main housing 10 by about a distance H is provided, the middle finger 103 can be naturally guided to the center of the body part 7a of the trigger 7 by the protruding part 12. The trigger 7 can be operated by carrying out a pulling operation of the middle finger 103 in the central-axis direction of the first grip part, and variable speed drive of the motor 4 can be easily carried out.

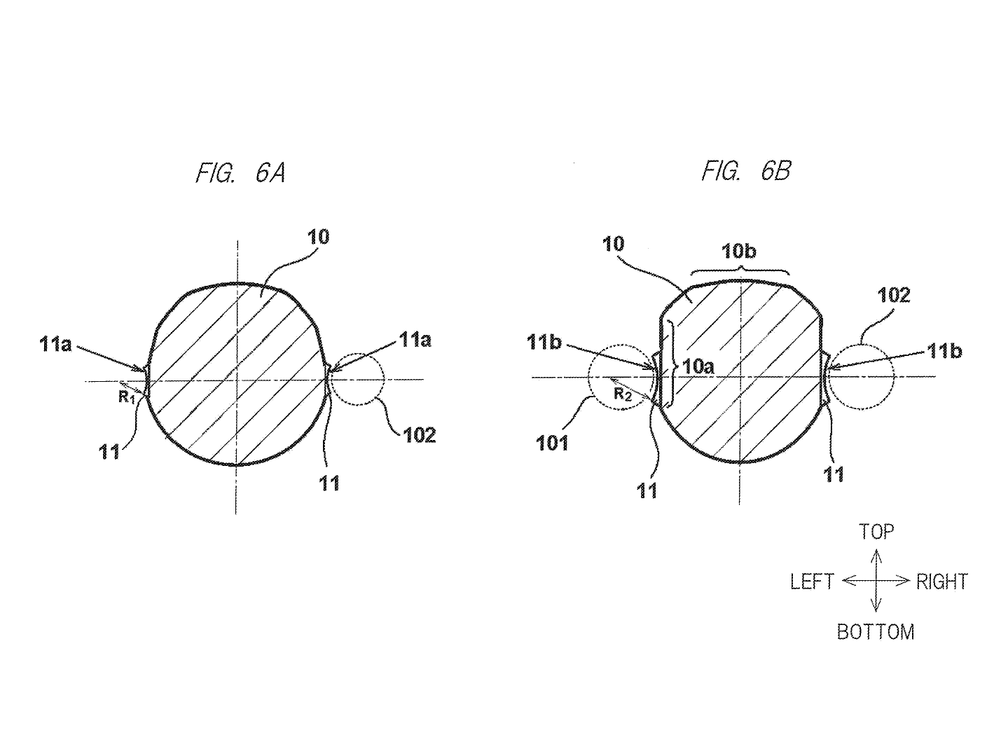

FIG. 5 is a diagram of viewing the situation of the gripping method of FIG. 4 from above. When gripping in this manner, the thumb 101 is positioned on the left side of the main housing 10, and the forefinger 102 is positioned on the right side of the main housing. In this case, the finger branch base 106 (see FIG. 13) is positioned on the extension line of the central axis of the main housing 10; therefore, the operator can easily cause the frontward pressing force to act on the power tool 1, and a tightening operation which is firm without wobbling can be carried out. Furthermore, the thumb 101 and the forefinger 102 in this case contact the non-slip treated parts 11a and 11b of the elastic body 11, which is the second grip part, and are therefore not easily slipped. The shape of the elastic body 11 will be described in further detail with reference to FIGS. 6A and 6B.

FIGS. 6A and 6B show the outer shape of the main housing 10. FIG. 6A shows the A-A part of FIG. 1, and FIG. 6B is a cross-sectional view of the B-B part of FIG. 1. To stabilize the fingers (the thumb 101 and the forefinger 102) which grip the main housing 10, the shape of the elastic body 11 has concaves in the vicinities of the top-bottom-direction centers of the both lateral surfaces of the main housing 10, and arc shapes which have recessed shapes are formed when viewed in the inner-diameter direction (central-axis direction) from the outer side. The elastic body 11 is formed so that the arcs having the recessed shapes are extended in this manner in the axial direction of the main housing 10.

FIG. 6A is a cross section of the vicinity of the A-A part of FIG. 1, and the thumb 101 does not reach the vicinity thereof although the forefinger 102 reach there. The curvature radius R₁ of the arc is formed to be somewhat small to fit the forefinger 102, and, since it has a recessed shape when viewed from the outer side, the center point of the curvature radius R₁ is outside of the main housing 10. FIG. 6B is a cross section of the vicinity of the B-B part of FIG. 1, and not only the forefinger 102 but also the thumb 101 reach the vicinity of the B-B part. Therefore, the curvature radius R₂ of the arc is formed to be somewhat large to fit the thumb 101 so that a relation of R₂>R₁ is obtained. Since the recessed shape is formed when viewed from the outer side, the center point of the curvature radius R₂ is positioned outside of the main housing 10 as well as that of R₁. In this manner, the curvature radius of the arc of the elastic body 11 is small on the front side of the main housing 10, and the curvature radius of the arc is increased gradually or stepwise as it gets close to the rear side. The degree of this change can be optionally set to fit the sizes of average fingers of operators.

As is understood from the cross-sectional view of FIG. 6B, the shape of a lateral surface 10a of the main housing is configured to be a surface which is substantially horizontal in the vertical direction. The soft materials (the elastic body 11) which are arc-shaped in this manner and have the shapes extended to the direction toward the distal end of the main housing 10 are provided on the both lateral surfaces of the main housing 10. Therefore, force can be easily applied in the rotation direction when being gripped as compared with a housing which has a completely round cross-sectional shape, and, particularly when being gripped in the manner shown in FIG. 3A, the movement to the direction in which the power tool is to be rotated can be easily suppressed. Furthermore, an upper-side part 10b of the main housing 10 is in a shape similar to a flat surface; therefore, force can be further easily applied in the rotation direction. These shapes of the main housing 10 were caused to be in the shapes which facilitate so-called hand rotation in which the main body of the main housing 10 is rotated by a hand (s) after the motor 4 is stopped.

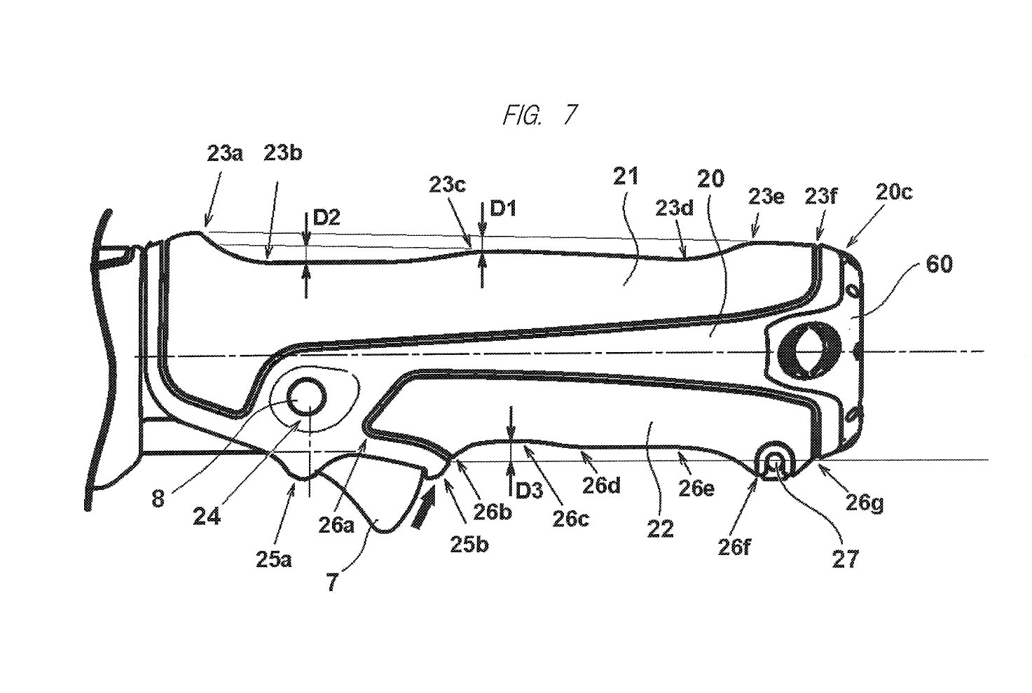

Next, a detailed shape of the handle housing 20 will be described with reference to FIG. 7. As described by FIG. 1, in the shape (upper side) of the part of the elastic body 21 of the handle housing 20, mainly the two recessed parts 23b and 23d are formed in a lateral view. In this case, when viewed from the flexion point 23c, the first recessed part 23b has a shape which is hollowed by a depth D2. The axial-direction length (length in the front-rear direction) from the front end 23a to the flexion point 23c is preferred to be about an average width of two fingers (the forefinger and the middle finger) of adult males.

The second recessed part 23d is formed also from the flexion point 23c to the rear side (the vicinity of the rear of the trigger 7); however, the recessed part 23d rather has a substantially the same height as the flexion point 23c than being a concave, and the rear step part 23e is higher than them in this state. The vicinity of the center of the grip part is configured to be recognizable by a tactile sensation by the flexion point 23c, and the vicinity of the rear end of the grip part is configured to be recognizable by the rear step part 23e. If the frontend 23a and the rear step part 23e are connected to each other by a straight line, the flexion point 23c is hollowed by about D1. The elastic body 21 is disposed up to a rear end part 23f, which is positioned in the vicinity of the opening 20c of the handle housing 20.

In the shape of the part (lower side) of the elastic body 22 of the handle housing 20, mainly two recessed parts 26c and 26e are formed. In this case, when viewed from a flexion point 26d, the recessed part 26c is formed on the front side, and the recessed part 26c is formed on the rear side. A front end 26a of the elastic body 22 is positioned in the vicinity of the swinging shaft 43 of the trigger 7 (see FIG. 2), and a left-right coupling front end 26b is positioned in the vicinity of the rear end of the trigger 7. Since a hook hole 27 is provided in the region in which the elastic body 22 is provided, the elastic body 22 includes the shape of a protruding part 26f, which is downwardly protruded. The elastic body 22 is disposed up to a rear end part 26g, which is positioned in the vicinity of the opening 20c of the handle housing 20.

As described above, in the case of the gun-type shape and the gripping method shown in FIGS. 4 and 5, the both lateral surfaces of the main housing 10 are gripped by the thumb 101 and the forefinger 102. Therefore, the output shaft 56 is stabilized, and the force from the part under finger web 106 toward the tip tool (driver bit 58) side can be easily applied. In this case, the middle finger 103, which operates the trigger 7, can carry out operation so as to pull the trigger 7 in the central-axis direction of the handle housing while being in contact with a bottom surface (particularly, the protruding part 12) of the main housing 10; therefore, a natural trigger operation can be carried out. Moreover, the body part 7a of the trigger 7 is exposed at a position where the middle finger 103 is fully pulled in the central-axis direction of the handle housing; therefore, erroneous operations of the trigger 7 can be effectively prevented.

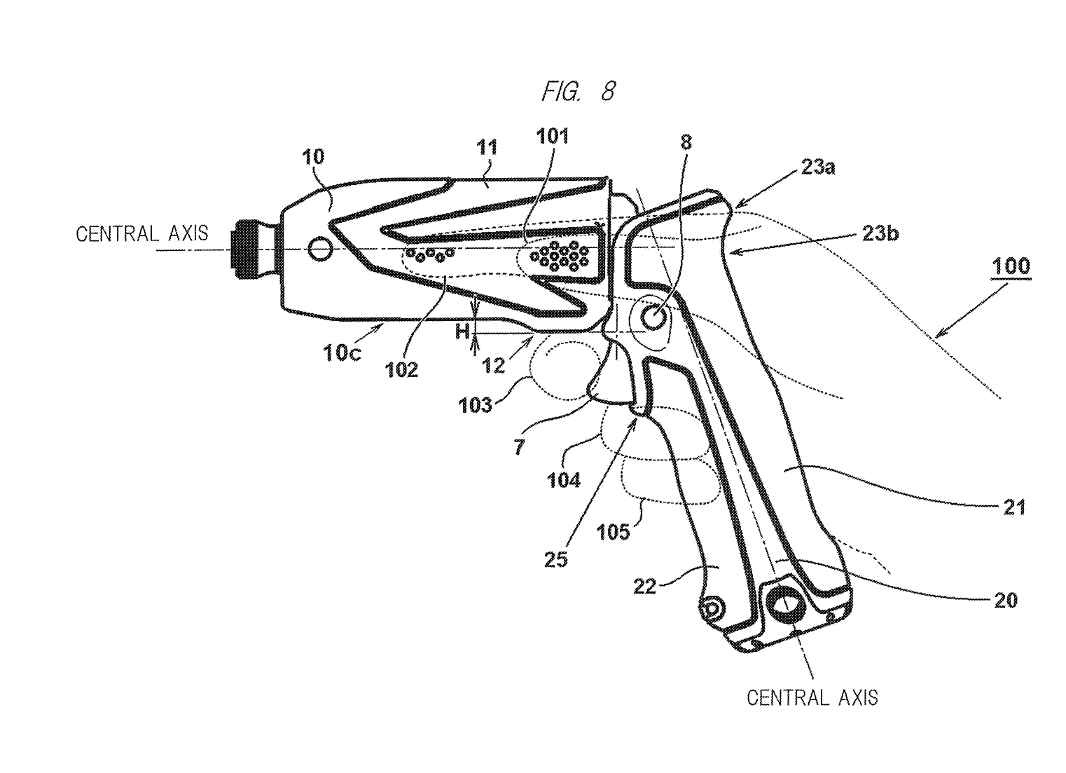

FIG. 8 is a lateral view showing another gripping state in the case in which the power tool 1 according to the first embodiment of the present invention is folded and also showing a state in which the forward/reverse switching lever 8 is being operated by the thumb 101. This state can be used as a holding way similar to that of so-called gun-type power tools such as widely-spread impact drivers and driver drills. Moreover, in the present embodiment, the trigger 7 is provided on the handle housing 20 side and in the vicinity of the immediately lower side of the turning mechanism, and the trigger 7 is therefore positioned at a location where the forefinger 102 is positioned; therefore, a very easy-to-use power tool can be achieved. Furthermore, in the case of this way of holding, the push-type forward/reverse switching lever 8 on the both lateral surfaces of the handle housing 20 is positioned above the forefinger 102. Therefore, when the power tool 1 is folded and used in the manner shown in FIG. 8, the forward/reverse switching lever 8 is positioned above the trigger 7 (or the swinging shaft 43); therefore, the forward/reverse switching lever 8 can be easily operated by moving the thumb 101 or the forefinger 102.

Also when the forward/reverse switching lever 8 is to be operated, the handle housing 20 can be retained by the middle finger 103, the ring finger 104, and the little finger 105; therefore, there is no need to switch the way of holding the power tool 1 or to support the power tool 1 with the left hand. Furthermore, the vicinity of the rear end of the lower side of the main housing 10 is configured to have a flat surface, i.e., the protruding part 12 protruding to the lower side of the vicinity of a bottom surface part 10c. Since the protruding part 12 is formed, only by lifting up the power tool 1 with one hand and bending the forefinger, in the case of holding with the right hand, along the lower end surface of the main housing 10, the forefinger can be guided to an appropriate position in front of the trigger 7. Therefore, usability can be further improved.

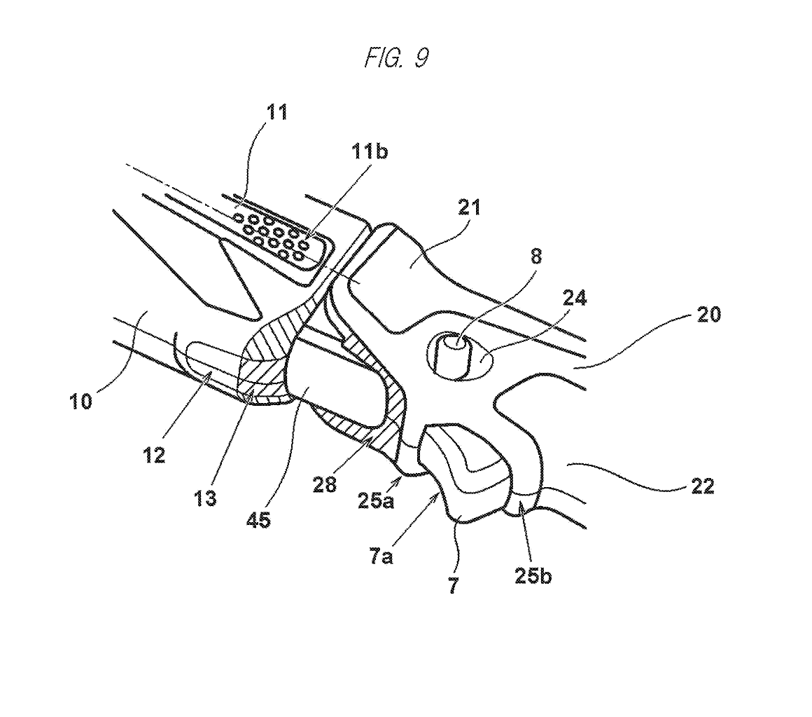

FIG. 9 is a partial perspective view (straight state) for explaining the shapes of the main housing 10 and the handle housing 20 in the vicinity of the turning mechanism. The housing of the present embodiment has a shape that, in the vicinity of the rear end of the main housing 10, a part opposed to the vicinity of the lower side of the front end part of the handle housing 20 is beveled. More specifically, in hatched parts 13 and 28, curved surfaces which are converged from the flat surfaces on one side toward the flat surfaces on the other side are provided, and the surfaces are configured to be smoothly connected to each other.

Since the shapes chamfered (beveled) in this manner are used, when the handle housing 20 is turned with respect to the main housing 10, most of the vicinities of the rear end surfaces of the hatched parts 13 and 28 are not brought into contact with each other. A protruding part 25a protruding downward is formed in the vicinity of the front end of the trigger 7, and a protruding part (trigger tongue) 25b protruding downward is formed in the vicinity of the rear end of the trigger 7 so that they exert effect of preventing slippage of the finger(s), which is retaining the power tool 1, and guiding the finger(s) of the operator to a predetermined position (the trigger 7 or the elastic body 22).

The push-type forward/reverse switching lever 8 exposed to the both lateral surfaces of the handle housing 20 is disposed in the tapered concave 24 and is configured to be a short lever so as not to interfere with the hand(s) and fingers gripping the handle housing 20. Therefore, the operator is capable of easily carrying out a switching operation while holding the first grip part (the elastic bodies 21 and 22) and is capable of preventing unintentional application of force to the forward/reverse switching lever 8 while carrying out a tightening operation. It is preferred to mechanically lock the lever so that the forward/reverse switching lever 8 cannot be moved while the trigger 7 is being pulled or use a configuration so as to electrically lock the lever so that the lever is not reacted even when the forward/reverse switching lever 8 is moved.

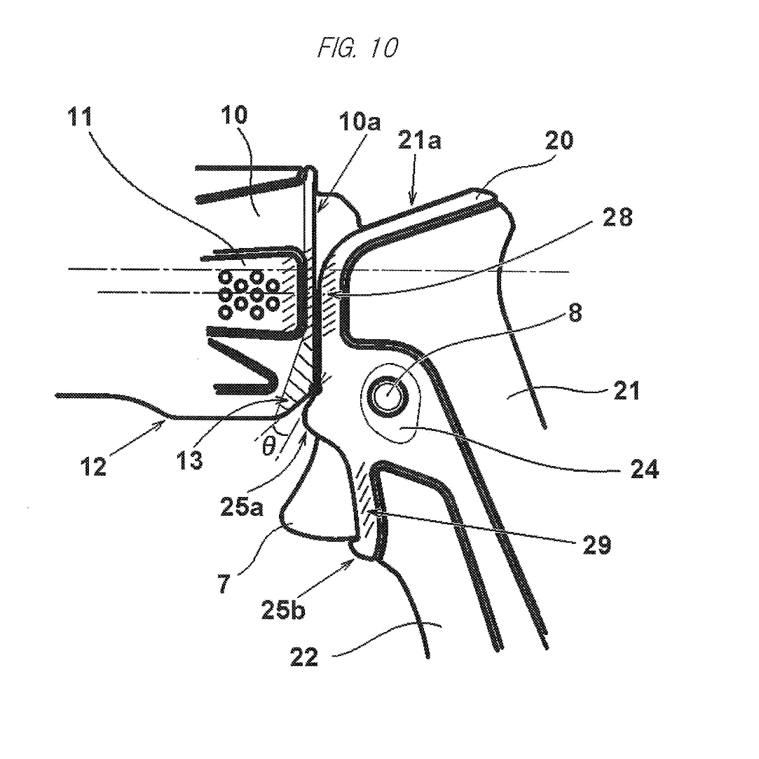

FIG. 10 is a partial perspective view (folded state) for explaining the shape in the vicinity of the turning mechanism of the main housing 10 and the handle housing 20. The vicinity of a hinge mutually coupling the main housing 10 and the handle housing 20 is provided with an effect of pushing the finger(s) outward upon turning so that the finger(s) is not squeezed therein. Therefore, the end faces of the main housing 10 and the handle housing 20 are formed at an angle by which the end faces are mutually bidirectionally parallel or not intersected. In FIG. 10, if the hatched parts 13 and 28 have not undergone chamfering (beveling) processing, they are joined with each other; however, in the present embodiment, the hatched parts 13 and 28 are configured to have the shapes which have undergone beveling processing, a gap corresponding to an angle (θ) is formed therebetween.

Furthermore, the protruding part 25a is formed above the trigger 7; therefore, even if the forefinger, etc. are in the vicinity of the trigger 7 upon folding, the forefinger can be naturally guided to the pressing surface of the trigger 7 in combination with the shape of the protruding parts 12 and 25a without squeezing the finger(s) in the vicinities of the hatched parts 13 and 28. Note that the protruding part 25a is caused to protrude mainly for housing the swinging shaft 43, and the protruding part 25b is provided for guiding the gripping finger(s). The elastic body 22 is formed up to the vicinity of the lower side of the protruding part 25b; therefore, the finger which pulls the trigger 7 can be positioned at a predetermined position, and a comfortable gripping feeling is achieved by the elastic body 22, which is a soft material. A hatched part 29 also has a shape chamfered (beveled) so that a step or unevenness from the trigger 7 to the elastic body 22 is eliminated.

As described above, according to the present embodiment, the vicinity of a hinge mechanism (turning mechanism) mutually coupling the grip parts of the main housing 10 and the handle housing 20 has a shape which has an effect of pushing the finger(s) to the outside upon turning, and the end faces thereof (the vicinities of the hatched parts 13 and 28) are formed at the angle (θ) by which the end faces are mutually bidirectionally parallel or not intersected; therefore, the finger(s) can be effectively prevented from being squeezed therein. The angle (θ) is about 20 degrees in the present embodiment, but maybe suitably set in a range about 10 to 30 degrees.

### Second Embodiment

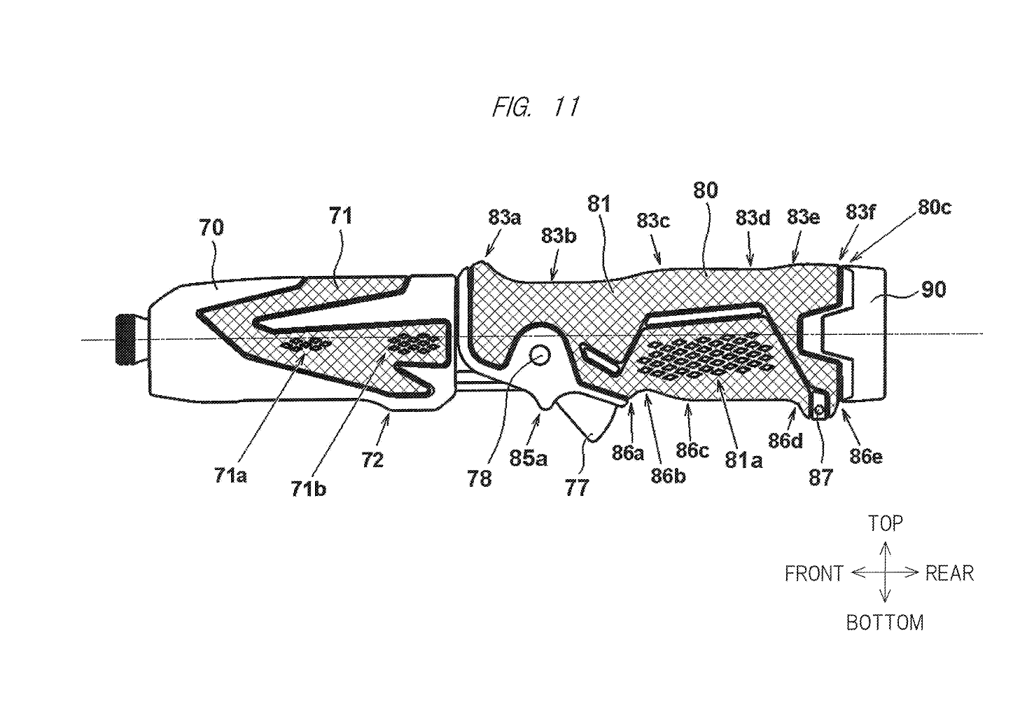

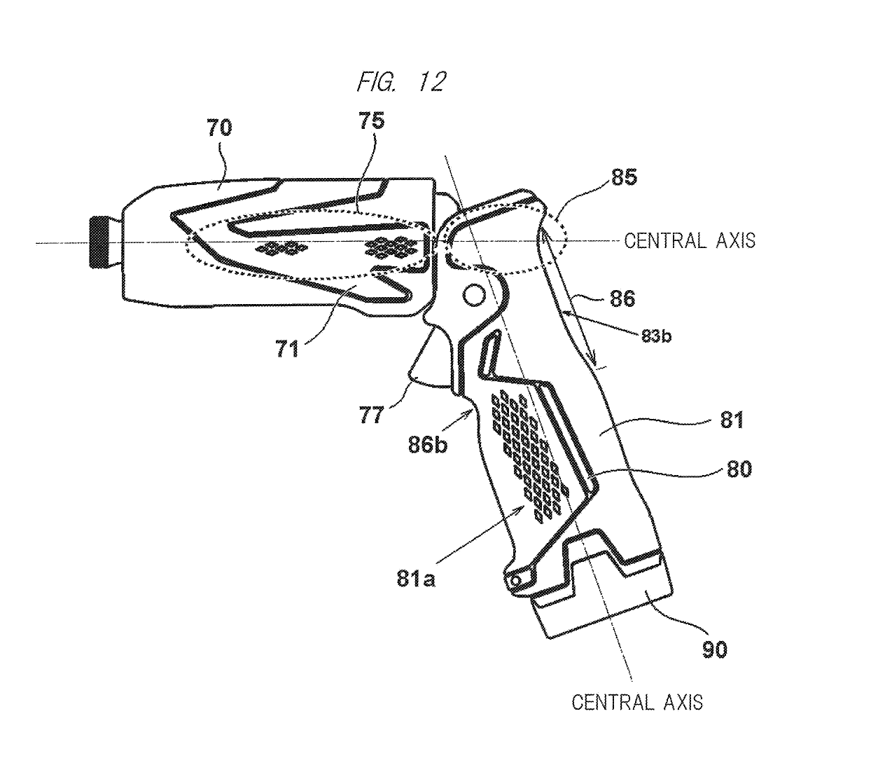

Next, a second embodiment will be described with reference to FIGS. 11 and 12. FIG. 11 is a lateral view showing an appearance of the straight state of the power tool 1 according to the second embodiment. The configuration of the second embodiment is basically similar to that of the first embodiment; however, there is a difference in the shape of an elastic body 81 constituting a first grip part of a handle housing 80. The elastic body 81 is configured so as to be continued to the upper side and the lower side in the straight state as shown in FIG. 11, and a plurality of recessed parts 81a for slip resistance are formed in a lower part thereof. The detailed shape of the handle housing 80 in FIG. 11 is substantially similar to that of the first embodiment; and, in an upper part of the elastic body 81, a front end 83a thereof is formed so as to be extended up to the vicinity of the part that contacts a main housing 70. A rear end 83f is disposed so as to be largely extended up to the vicinity of an opening 80c, which houses a battery pack 90.

In the shape of the upper side of the handle housing 80, a flexion point 83c is provided between the front end 83a and the rear end 83f, a recessed part 83b is provided on the front side of the flexion point 83c, and a recessed part 83d is formed on the rear side of the flexion point 83c and between there and step part 83e. The front-rear-direction width of the recessed part 83b is preferred to have a length corresponding to about the total of the forefinger 102 and the middle finger 103. The recessed part 83b is not required to be largely hollowed; and the recessed part 83b may be substantially a slight concave as shown in FIG. 11 as long as the operator can find out the relative positional relations of the flexion point 83c, the recessed part 83b, and the step part 83e by the tactile sensations thereof.

In the lower part of the elastic body 81 of the handle housing 80, a lower front end 86a is positioned on the rear side of a trigger 77. A concave 86b, which substantially accommodates the middle finger 103, is formed on the immediately rear side of the lower front end 86a, and, in the rear thereof, a smooth surface (curved surface) is formed from a flexion point 86c to a step part 86d. A hook hole 87 is formed immediately behind the step part 86d, and the elastic body 81 is configured so as to reach a lower rear end 86e in the rear side of the hook hole 87. A protruding part 85a is formed on the front side of the trigger 77, and a forward/reverse switching lever 78 is disposed thereabove. The shape of an elastic body 71 serving as a second grip part formed in the main housing 70 side is substantially similar to that of the elastic body 11 of the first embodiment; however, the shapes of recessed parts 71a and 71b serving as non-slip treated parts are somewhat different from those of the first embodiment. However, the difference thereof is derived from design factors, and the shape of the elastic body 71 and the recessed parts 71a and 71b shown in FIG. 11 may have other optional shapes. The point that a protruding part 72 serving as a bulge which serves as a guide of movement of the finger(s) to the trigger is provided in the rear of the bottom surface of the main housing 10 is similar to the first embodiment.

FIG. 12 is a diagram showing a state in which the handle housing 80 is turned from the state of FIG. 11 to obtain the so-called gun-type shape. Also in this case, as well as the first embodiment, an upper part (region 75) of the elastic body 81 serving as the first grip part and a lateral surface part (region 85) of the elastic body 81 serving as the second grip part are disposed so as to be serially aligned on the central axis of the main housing 70 when viewed from a lateral surface as shown in FIG. 12. When serially aligned and disposed in this manner, in the case of the gripping method shown in FIGS. 4 and 5, the main housing 70 can be firmly retained by the thumb 101 and the forefinger 102 while holding the region 85 toward the front by the part under finger web 106 in combination with formation of the second grip part. The length 86 of the recessed part 83b is preferred to be set so as to have a length longer than the width of two fingers.

### Third Embodiment

Next, a third embodiment will be described with reference to FIGS. 14 to 17. A power tool 301 uses a chargeable battery pack 330 as an electric power source, uses a motor 304 as a drive source to apply rotative force and striking force to an output shaft 326 via a power transmission system, and transmits the rotative striking force to an unillustrated tip tool such as a driver bit retained by an attachment hole 326a covered with a sleeve 327, thereby carrying out operation of screw tightening, bolt tightening, etc. A housing of the power tool 301 is comprised of a front housing 303 and a rear housing 302. The front housing 303 is formed by molding of a synthetic resin such as plastic so as to be dividable into two to the left and the right, and the left-right parts are fixed by later-described screws. An LED 314 for irradiating a tip tool, a tightened material, etc. is provided at a lower side of the sleeve 327 of the front housing 303.

The rear housing 302 is formed to have a cylindrical shape having an opening 302c at the rear end thereof and is manufactured by a left-right division style by integral molding of a polymer resin product such as plastic. The front housing 303 and the rear housing 302 are coupled to each other by a turning shaft 310 and are turnable about the turning shaft 310 by about 70 degrees. The plane that turns is the plane including the front-rear and top-bottom directions as viewed in FIG. 14 (the plane same as the paper surface), and the shape of the so-called straight type in which the rear housing 302 and the front housing 303 are aligned having the same axis in the manner of FIG. 14 can be changed into the shape turned in the manner as shown in later-described FIG. 15, i.e., into the shape of a so-called gun type. Upon carrying out the operation, an operator can set either mode of the straight-type or gun-type shape depending on the location or target of operation.

The motor 304 is a brushed DC motor used as a drive source for rotating the unillustrated tip tool and is housed on the rear side of the front housing 303. In the present embodiment, the battery pack 330 is used as an electric power source for driving the motor 304. A rotation shaft of the motor 304 is connected to a power transmission system for rotating the tip tool. In the present embodiment, the power transmission system is comprised of a speed reducing mechanism 318, which uses planetary wheels, and a striking mechanism 320 having a hammer 322 and an anvil 325, and they are serially disposed to have the same axis as the motor 304.

The speed reducing mechanism 318 has a sun gear attached to the rotation shaft of the motor 304, a plurality of planetary gears, and a fixed-type ring gear on the outer peripheral side of the planetary gears. In the speed reducing mechanism 318, a planetary carrier for fixing a rotation shaft of the plurality of planetary gears is rotated. A widely used publicly-known striking mechanism (impact mechanism) can be used as the striking mechanism 320. The striking mechanism 320 is comprised of: a spindle 321, which is connected to the planetary carrier; a hammer 322, which is movable in an axial direction; a spring 324, which biases the hammer 322; cam grooves; balls; etc. A spindle lock mechanism 319, which prevents relative rotation of an output shaft 326 with respect to the front housing 303 when the motor 304 is stopped, is provided between the striking mechanism 320 and the sleeve 327. The spindle lock mechanism 319 is a lock mechanism for carrying out hand tightening by rotating the power tool 301 as if the power tool is a driver after rotation of the motor 304 is stopped. Since a specific structure of the spindle lock mechanism 319 is publicly known, the explanation thereof is omitted herein.

The battery pack 330 has a substantially cylindrical chassis, which is attachable and detachable to and from internal space through the opening 302c of the end part of the rear housing 302, and the battery pack is an electric power source which is of a so-called cassette type and easily replaceable. Hooking parts 331a are provided at two locations on the chassis of the battery pack 330, and, when they are engaged with recessed parts (not illustrated) formed on the inner wall of the rear housing 302, the battery pack 330 is retained. In order to detach the battery pack 330, the battery pack 330 is pulled from the opening 302c while pressing latch parts 331 provided at two locations on the left and the right. The shape of the rear end part of the battery pack 330 is formed so as to cover the opening 302c of the rear housing 302, and the rear surface of the battery pack 330 forms part of an outer edge part of the rear housing 302. A connector 332 is provided at a substantially rectangular corner part of the front end of the battery pack 330, and a plurality of metal-made terminals 312 are fixed to a terminal base 311 of the rear housing 302.

When the battery pack 330 is attached to the interior of the rear housing 302, the connector 332 is brought into contact with the plurality of terminals 312 on the power tool 301 side. As a result, a state in which electric power from the battery pack 330 can be supplied to the motor 304 is obtained. In the battery pack 330, for example, two lithium-ion cells of the 18650 size are housed; however, the size and the number of the housed secondary batteries are optional, and cells of the 14500 size may be used for downsizing. The housed batteries are not limited to secondary batteries, but also may be primary batteries such as dry-cell batteries.

In the space which is inside the rear housing 302 and is between the battery pack 330 and the turning shaft 310, a switch (main switch) 306, which controls supply/stoppage of electric power to the motor 304, and a forward/reverse switch 308 for switching the rotation direction of the motor 304 are housed. In the present embodiment, the switch 306 employs a so-called variable resistance switch in which the resistance value thereof is varied depending on the operation amount of a plunger 306a, and the rotation speed of the motor 304 is variable depending on the operation amount of the switch 306. The plunger 306a of the switch 306 is operated by a trigger part 307, and a part for connection to the plunger 306a is slid in the top-bottom (vertical) direction.

The part connected to the plunger 306a is configured to be movable in the top-bottom direction when the front side of the trigger part 307 is swung (turned) about the swinging shaft (swing supporting point) 313 by a predetermined angle. In the present embodiment, a swinging shaft 313 is provided in the front side of the trigger part 307; therefore, the operator who holds the rear housing 302 also serving as the grip part is capable of easily holding the trigger part 307, and the power tool 301 having the easy-to-use switch mechanism was achieved.

The forward/reverse switch 308 is provided in the space which is in the front side of the switch 306 and is between the switch 306 and the turning shaft 310. The forward/reverse switch 308 is a switch for switching the rotation direction of the motor 304 to a “forward rotation direction (tightening direction)” and a “reverse rotation direction (loosening direction)”. The forward/reverse switch 308 can be operated by sliding a lever part thereof in the left-right direction; wherein, a mechanical or electrical lock mechanism is preferred to be achieved by providing not only providing the lever member with two locations of a forward-rotation-direction position and a reverse-rotation-direction position, but also providing a lock position therebetween so that, at the lock position, the trigger part 307 is mechanically locked to be immobile or the motor 304 is configured to be not electrically turned on even when the trigger part 307 is pulled.

The cover 315 is disposed in the vicinity of the turning shaft 310 and in the side toward which the front housing 303 and the rear housing 302 are folded (the side in which a narrow angle is formed). In a way opposite to that of the power tool shown in FIGS. 34 and 35, the cover 315 is retained by a turning shaft (supporting point) 316, which is provided on the rear housing 302 side. As a role of the cover 315, the cover plays a role as an outer frame part which covers the space in the vicinity of the part of the turning mechanism between the front housing 303 and the rear housing 302 when the power tool 301 is used in the mode shown in FIG. 14, i.e., the straight form, and the cover is a plate-like member. Particularly, in the power tool in which the battery pack 330 is disposed in the rear housing 302, a lead wire 309a, which supplies electric power to the motor 304, and a lead wire 309b, which supplies electric power to an LED 314, have to be disposed in the vicinity of the turning shaft 310; therefore, the power tool has the structure which is provided with the space for allowing their extension.

As is understood from FIG. 14, the present embodiment is configured so that the cover 315 is axially supported on the rear housing 302 side, the switch 306 and the trigger part 307 can be therefore easily disposed in the rear housing 302. The length L_{T} in the axial direction (front-rear direction) occupied by the trigger part 307 is provided so as not to be overlapped with, when viewed in the axial direction, the length L_{B} occupied by the battery pack 330 when viewed in the axial direction of the rear housing 302. Furthermore, in the straight state, the axial-direction length L_{T} of the cover 315 is disposed so as not to be overlapped with each of the axial-direction length L_{M} of the motor 4 and the axial-direction length L_{T} occupied by the trigger part 307. On the other hand, the axial-direction length L_{S} occupied by housing space 317 in which the cover 315 is moved is disposed so as to be overlapped with the axial-direction length L_{M} of the motor 304. In this manner, the axial-direction length L_{S} of the housing space 317 can be ensured without moving the disposition of the motor 304; therefore, the front-side housing is not required to be enlarged in the axial direction in order to dispose the housing space 317.

In the present embodiment, the turning shaft 310 of the turning mechanism of the housings, the turning shaft 316 of the cover 315, and the swinging shaft 313 of the trigger part 307 are disposed in parallel to each other so as to be extended in the left-right direction. The turning shaft 310 (the front-rear-direction position thereof is at an arrow A₁), the turning shaft 316 (the front-rear-direction position thereof is at an arrow A₂), and the swinging shaft 313 (the front-rear-direction position thereof is at an arrow A₃) are sequentially disposed from the front to the rear. This means that the turning shaft 316 and the swinging shaft 313 are disposed in the rear of the turning shaft 310, in other words, are disposed inside the rear housing 302; therefore, the structure of the front housing 303 can be simplified, and the assembling performance thereof can be improved.

Furthermore, the front housing 303 is not required to house a switch mechanism between the motor 304 and the turning shaft 310 different from the conventional technique shown in FIGS. 34 and 35; therefore, the axial-direction length of the front housing 303 can be made shorter by the length of the switch mechanism. Furthermore, the diameter of the motor 304 is made small with respect to the outer diameter of the battery pack 330; therefore, this is optimum for forming the housing space 317 since sufficient space can be ensured in the periphery, particularly, below the motor 304. In a cross section of the cover perpendicular to the axial direction of the cover 315, an opening has an upright U-shape; therefore, note that, when viewed in FIG. 14, the height of the cover 315 (lateral surface of the cover 315) and the height of the housing space 317 (cross section of the center part) do not match with each other.

FIG. 15 is a vertical cross-sectional view of the power tool 301 caused to be in the state of the so-called gun type by relatively turning the rear housing 302 and the front housing 303 from the state of FIG. 14. The axial direction of the swinging shaft 313 is disposed so as to be in the left-right direction of the rear housing 302. This is the direction perpendicular when viewed from the turning plane (the plane same as the paper surface). In the inner side of the vicinity of the front end of the trigger part 307, a convex part 307b, which abuts the inner wall in the vicinity of the opening of the rear housing 302, is formed. Part of the switch-side surface of the trigger part 307 abuts the plunger 306a; however, the plunger 306a is biased by a compressed spring 306b toward the direction in which it projects from the switch 306. When the operator cancels gripping of the trigger part 307, the effect of the compressed spring 306b causes the convex part 307b to return to a position at which the convex part 307b abuts the inner wall in the vicinity of the opening, in other words, to the position at which the motor 304 is turned off.

When using in the state of the gun type as shown in FIG. 15, the cover 315 enters the housing space 317 of the front housing 303. The cover 315 is not necessary in the gun-type state since the space in the vicinity of the turning shaft 310 is covered with the rear housing 302. In the present embodiment, the turning shaft 316 of the cover 315 is disposed on the rear housing 302 side so that the cover 315 can be housed into the housing space 317 on the front housing 303 side while being turned about the turning shaft 316 with respect to the rear housing 302. As a result of using the above-described structure, when the switch 306, which controls supply/stoppage of electric power to the motor 304, is disposed on the rear housing 302 side, the switch 306 can be disposed to be close to the vicinity of the turning shaft 310, the length of the rear housing 2 can be significantly shortened, and the size of the whole of the power tool 301 and the weight thereof can be reduced. In addition, since the switch 306 is disposed to be close to the vicinity of the turning shaft 310, when used in the gun type as shown in FIG. 2, operability similar to an impact driver of a general (T-type) battery-driven type can be obtained.

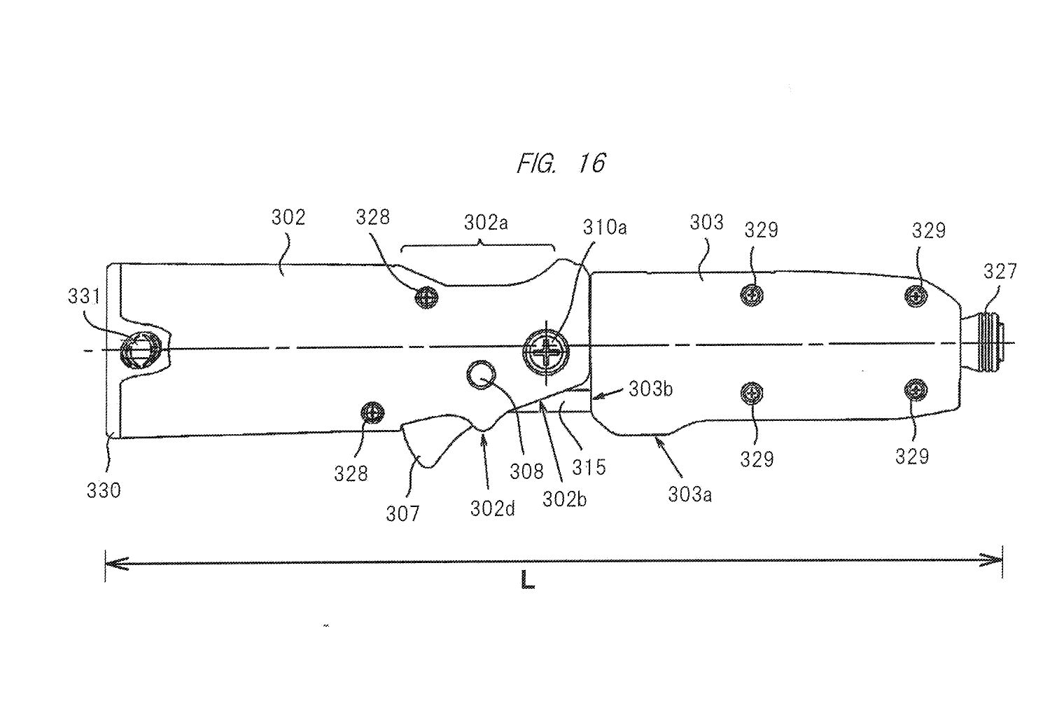

FIG. 16 is a lateral view showing an aspect of the straight state of the power tool 301 of the present embodiment. As to the rear housing 302, left-right divided housings are joined with each other by two screws 328; and, as to the front housing 303, left-right divided housings are joined with each other by four screws 329. The rear housing 302 and the front housing 303 are turnably joined by a screw 310a, which serves as the turning shaft 310. The aspect shown in FIG. 15 is used when the power tool 301 is not used, in other words, used as an aspect of a storage state; operation such as tightening can be carried out even in this aspect of the straight state. In the straight state, the operator uses the power tool 301 while gripping the rear housing 302 by one hand and applying pressing force toward the tip tool side (front side). In this process, the operator operates the trigger part 307 with the forefinger while holding a concave part 302a having a narrowed diameter of the rear housing 302. In this process, the trigger part 307 is positioned at a tip part of the forefinger; therefore, the operation can be naturally carried out. A protruding part 302d, which is projecting in the downward direction, is formed on the front side of the trigger part 307; therefore, the protruding part 302d functions as a guide in the case in which the finger (s) is placed around the trigger part 307 and as a stopper which prevents the finger (s) from being slipped from the trigger part 307 to the front side. The operator can determine the tip part of the trigger part 307 by a tactile sensation since the protruding part 302d is provided.

In the present embodiment, the rotation speed of the motor 304 is varied depending on the pulled degree of the trigger part 307; therefore, a tightening operation can be effectively carried out while optionally adjusting the rotation speed. On the front side of the protruding part 302d, an oblique side part 302b, which is formed obliquely upward toward the front end part of the rear housing 302, is formed. When the rear housing 302 is turned, the oblique side part 302b abuts a rear end surface 303b of the front housing 303. Because of a reason that the oblique side part 302b has to be formed in this manner and a reason that the lead wires 309a and 309b have to be extended on the lower side of the turning shaft 310, the cover 315 is provided in the power tool 301 of the present embodiment; and, in the straight state, the cover 315 functions as a casing or part of the housing which covers the internal space for allowing extension of the lead wires 309a and 309b. In the folded state, the cover 315 is housed in housing space of the front housing 303. In order to ensure the housing space, a protruding part 303a, which is somewhat projecting downward, is formed on the lower side of the vicinity of the rear end of the front housing 303.

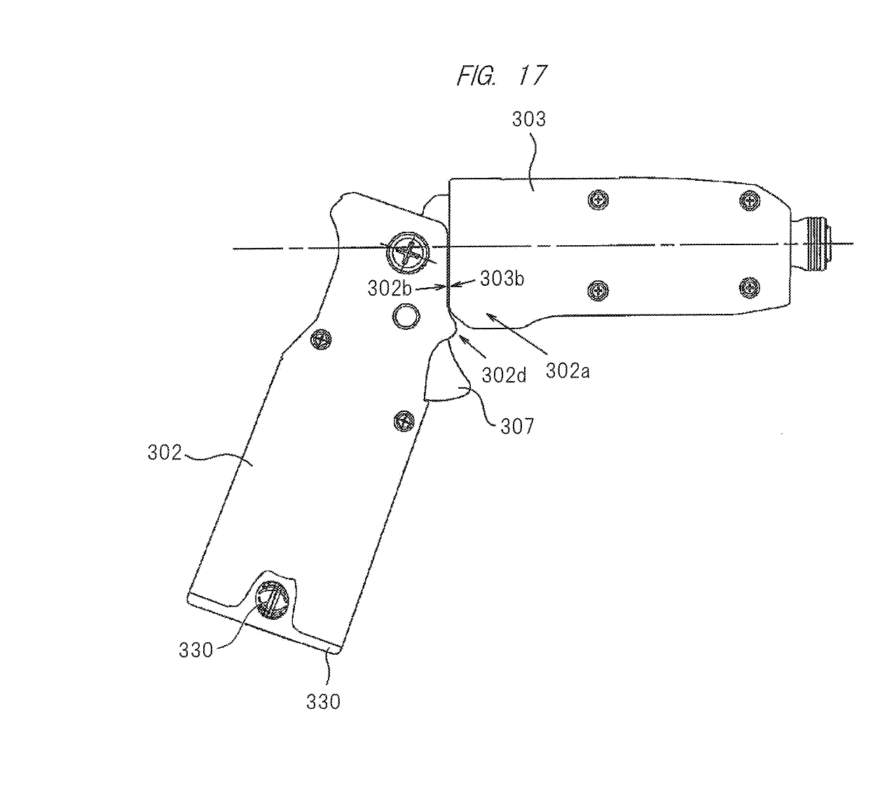

FIG. 17 is a lateral view showing an aspect of the folded state of the power tool 301 and is a diagram showing a state of carrying out an operation in the so-called gun-type aspect. In this state, the operator uses the power tool 301 while gripping the rear housing 302 and applying forward pressing force with respect to the front housing 303. Therefore, the operation can be carried out in the same state as the operation of a normal impact driver. In this process, the operator operates the trigger part 307 with the forefinger. In the case in which the operation is carried out in the gun-type shape in this manner, the aspect substantially the same as that of widely-used impact drivers, etc. is used, and the operation of the trigger part 307 by the operator is the same; therefore, a very easy-to-use folded-type power tool can be achieved.

As described above, in the present embodiment, in the internal space of the rear housing 302, the two switches, i.e., the switch 306 and the forward/reverse switch 308 are disposed between a front end surface of the battery pack 330 and the turning shaft 310. Furthermore, the trigger part 307, which can adjust the speed of the motor 304 depending on the operation amount thereof, is provided immediately below the switch 306; therefore, a very easy-to-use power tool was achieved. Moreover, the configuration of the switch part can be comparatively simply formed, and the manufacturing cost of the power tool can be effectively reduced. In the present embodiment, the two switches, i.e., the switch 306 and the forward/reverse switch 308 are mutually different parts; however, a switch unit of a combination type integrating them for the power tool may be used, or a switch mechanism which carries out variable speed control of the motor 304 and a switch mechanism which switches the rotation direction of the motor 304 maybe achieved by providing a plurality of types of switch units, contact point units, and variable capacity units on a circuit board to which the switch 306 is fixed.

### Fourth Embodiment

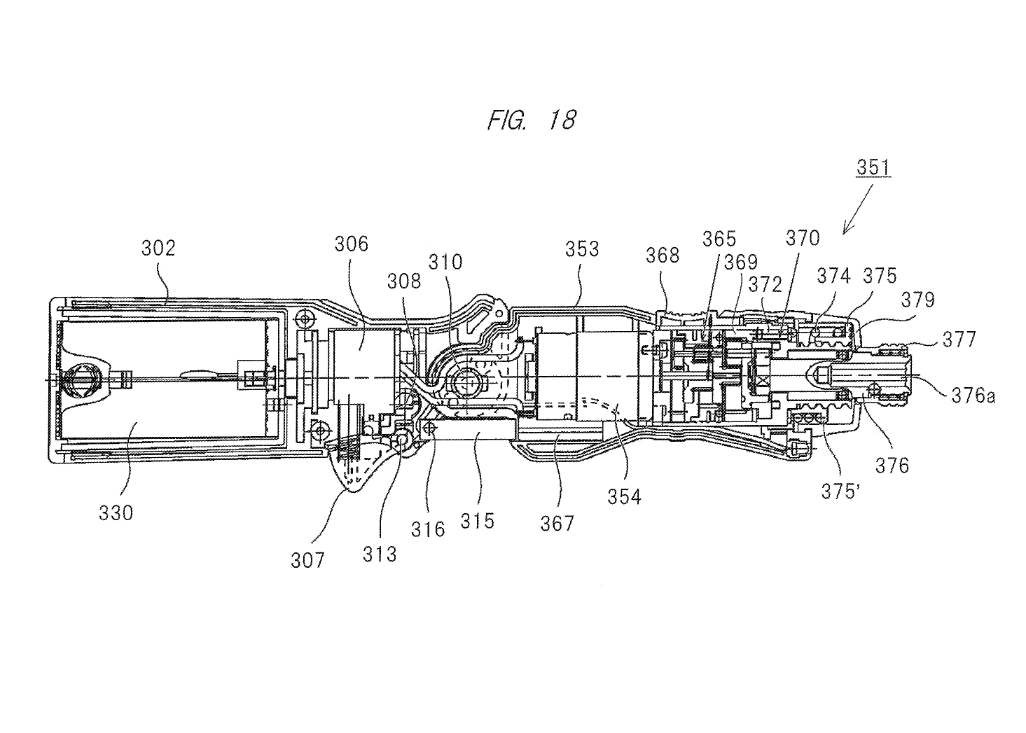

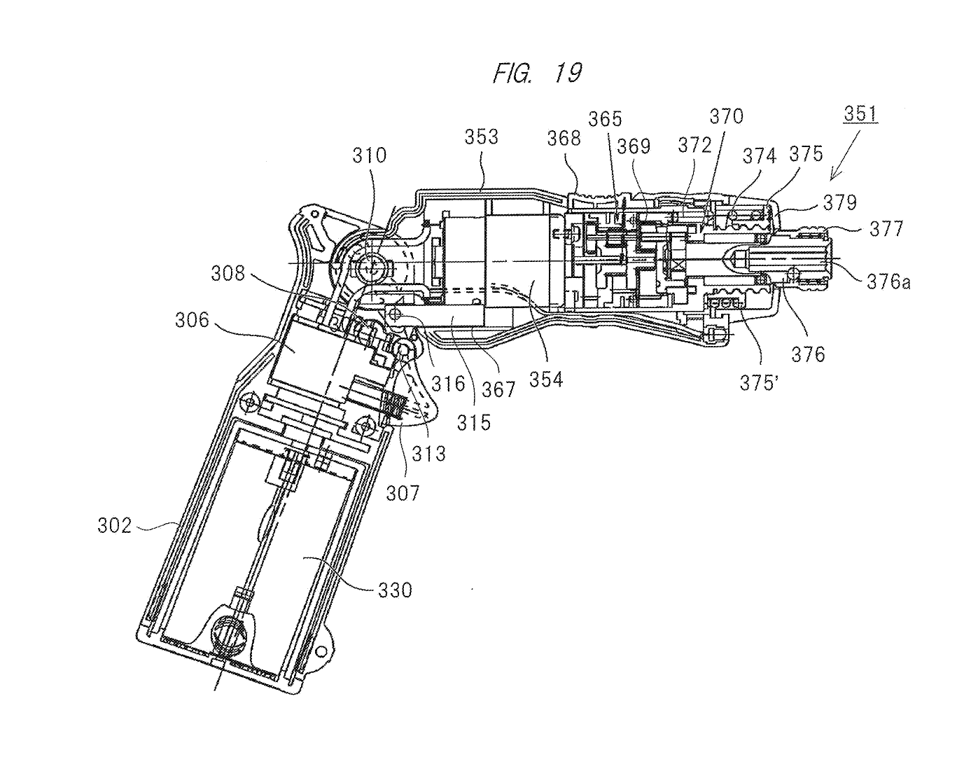

Next, a fourth embodiment of the present invention will be described with reference to FIGS. 18 and 19. FIG. 18 is a diagram showing an overall structure of a foldable power tool 351 (driver drill) and is a diagram showing a straight state. The driver drill carries out screw-tightening/boring by utilizing the rotative force obtained by subjecting the rotative force generated by a motor 354 to torque amplification by a speed reducing mechanism 365 in proportion to a speed reducing ratio. The internal structure of the rear housing 302 of the power tool 351 and the battery pack 330 have the same structures as those of the power tool 1 described in the first embodiment, and the same parts can be used therefor. In the fourth embodiment, the structure of a front housing 353 side is somewhat different, and a speed reducing mechanism 365 and a clutch mechanism 370 are contained as a power transmission system. Housing space 367 for housing a cover 315 in the folded state of the rear housing 302 is formed in the front housing 353 and below the motor 354.

The power tool 351 utilizes electric power, which is supplied by the battery pack 330, to rotate the motor 354 serving as a drive source. The rotation of the motor 354 is subjected to speed reduction by the speed reducing mechanism 365 and subjects an output shaft 376 to rotary drive at a predetermined speed via the clutch mechanism 370. The speed reducing mechanism 365 is comprised of, for example, a three-level planetary-wheel speed-reducing mechanism (speed-changing gear case) meshed with a pinion gear of a rotation shaft of the motor 354. Moreover, the speed reducing mechanism 365 has a shift knob 368 for switching a speed switching ratio, and two-level speed change to a low speed and a high speed is enabled when the operator carries out a switching operation of the shift knob 368. A housing of the power tool 351 is comprised of the front housing 353 and the rear housing 302. The front housing 353 and the rear housing 2 are turnable about the turning shaft 310 by about 70 degrees only; and operations can be carried out in a so-called straight-type shape in which the front housing 353 and the rear housing 302 have the same axis to each other as shown in FIG. 18 and in a so-called gun-type shape in which the state of FIG. 18 has been turned about the turning shaft 310 (described later with FIG. 19). The front housing 353 is configured to be dividable into two to the left and the right by molding of a synthetic resin such as plastic, and the left-right parts are fixed by unillustrated screws.

The clutch mechanism 370, which is disposed on the tip side of the front housing 353, controls whether rotation torque, which is obtained at the output shaft of the speed reducing mechanism 365, is to be transmitted to the output shaft 376 or not in response to load. Therefore, when desired tightening torque (load torque) is set in advance by a dial 379 for torque adjustment and mode switching, the clutch mechanism 370 has a function that, when the rotative force of the output shaft of the speed reducing mechanism 365 reaches the set tightening torque, the output shaft thereof is caused to idle to shut off the transmission of rotation from the speed reducing mechanism 365 to the output shaft 376.

The clutch mechanism 370 is comprised of: a pin 372, which is a clutch nail; a clutch nail, which is formed on a front end surface of a ring gear 369 constituting the third-level planetary-gear speed-reducing mechanism; a coil spring 374, which presses the pin 372 toward the rear in the axial direction; and a pressing member 375, which is movable in the axial direction in the front side of the coil spring 374. The pressing member 375 is rotated in synchronization when the dial 379 is rotated. When the dial 379 is operated to be rotated, the pressing member 375 is moved in the axial direction. When the pressing member 375 is moved in the axial direction (front-rear direction), the strength of the biasing force of the pin 372 toward the rear can be adjusted, and the tightening torque (load torque) can be adjusted. In FIG. 18, a cross-sectional view of the pressing member 375 at a foremost position is shown above the output shaft 376, and a cross-sectional view of a pressing member 375′ at a rearmost position is shown below the output shaft 376; however, they are shown to be virtually vertically asymmetrical in order to facilitate understanding. 375 denotes the state before the dial is turned where the coil spring 374 is stretched the most, and 375′ denotes the state after the dial 379 is turned where the coil spring 374 is compressed. The pressing member 375 is a ring-shaped member continued in the circumferential direction; therefore, in practice, the pressing member has a vertically symmetrical shape.

FIG. 19 is a diagram showing the overall structure of the foldable power tool 351 (driver drill) according to the fourth embodiment of the present invention and is a diagram showing a folded state. In the present embodiment, a switch is not disposed between the motor 354 and the turning shaft 310, different from the conventional power tool 101 shown in FIGS. 34 and 35. Therefore, the axial-direction length of the front housing 353 of the folded-type driver drill of which total length L tends to be long when the clutch mechanism 370 is contained can be short. On the other hand, the switch 306 is required to be provided in the rear housing 302; however, since the switch 306 and the trigger part 307 are efficiently disposed and since the cover 315 is axially supported to the rear housing 302 by the turning shaft 316, an efficient layout is enabled, and the rear housing 302 having a compact shape can be achieved. Also in the fourth embodiment, operability equivalent to that explained in FIG. 1 to FIG. 4 can be achieved, and the folded-type driver drill which is compact and easy to use can be achieved.

### Fifth Embodiment

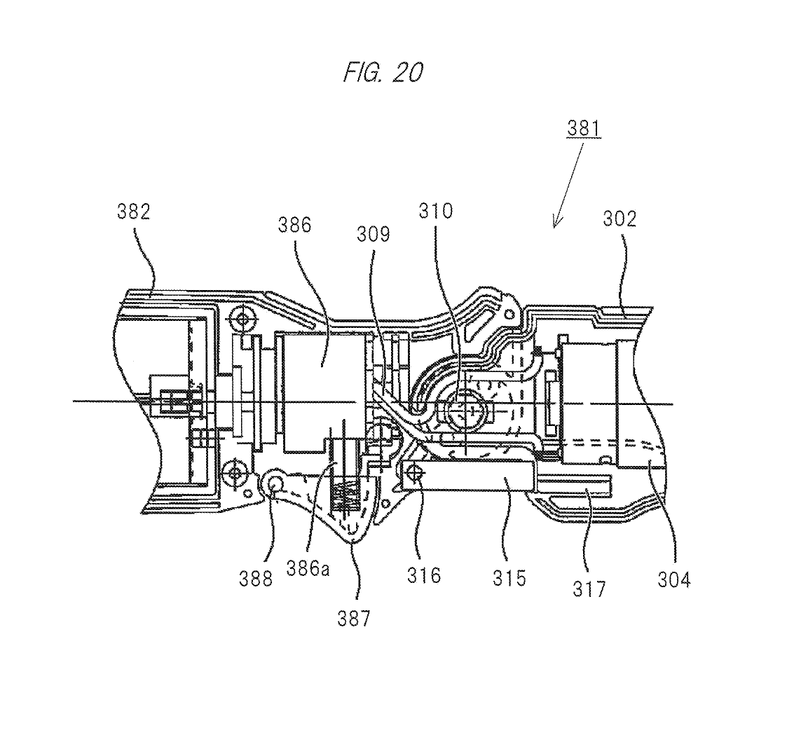

Next, a fifth embodiment of the present invention will be explained by using FIG. 20. FIG. 20 is a partial cross-sectional view of a power tool 381, wherein the configuration of a switch 386 and a trigger part 387 is similar to that of the third and fourth embodiments; however, the trigger part 387 of the present embodiment is axially supported by a swinging shaft 388 positioned in the rear, while the trigger part 307 of the third and fourth embodiments is axially supported in the front side. Therefore, the switch 86 is attached so that a plunger 386a is positioned not on the rear side but on the front side. This state is a form in which the switch 306 of the third and fourth embodiments is attached so that the front/rear thereof is reversed. Also in the fifth embodiment, the speed of the motor 304 can be adjusted by the pulling amount of the trigger part 387, and the easy-to-use foldable-type power tool can be achieved. The cover 315 is axially supported in the rear housing 302 by the turning shaft 316; however, as is understood from FIG. 20, the rear-most end position of the cover 315 and the front end position of the trigger part 387 are not overlapped with each other in the axial direction; therefore, the attachment structure of the trigger part 387 has some allowance. Moreover, when the housing is folded, the cover 315 is housed in the housing space 317 of the front housing 3; therefore, space efficiency is good.

### Sixth Embodiment

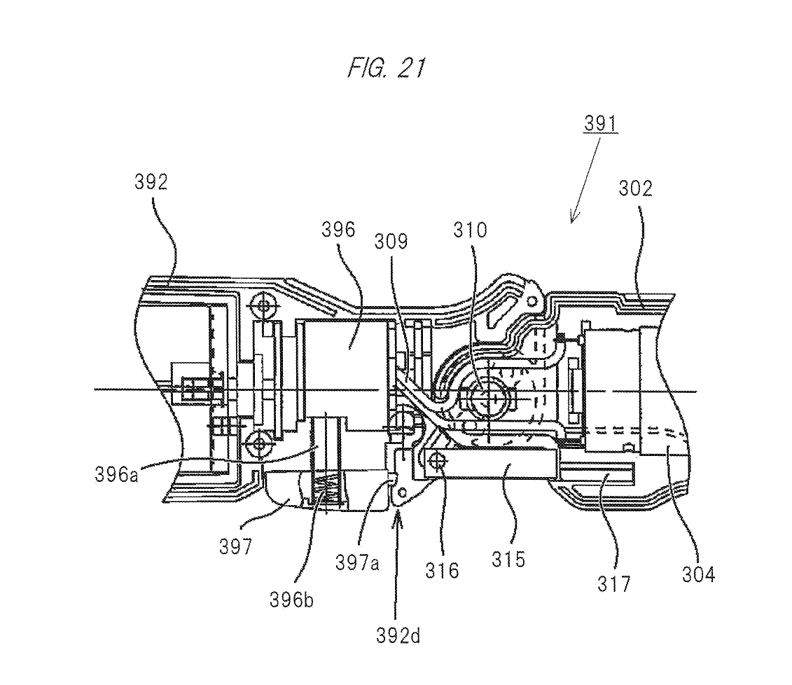

Next, a sixth embodiment of the present invention will be described with reference to FIG. 21. FIG. 21 is a partial cross-sectional view of a power tool 391; the configuration of a trigger part 397 is mainly different from that of the third and fourth embodiments and the trigger part 397 is configured to be of a slide type used in, for example, a widely-used impact driver or driver drill instead of the swing-type trigger part, which is axially supported. The trigger part 397 is fixed to a plunger 396a of a switch 396, and, basically, the switch 306 which is the same as that of the third and fourth embodiments may be used as the switch 396. A convex part 397a is formed in the vicinity of the front end of the trigger part 397, and the convex part 397a limits the movement position of the trigger part 397 by abutting an inner wall part of a protruding part 392d, which is formed on a rear housing 392.

An unillustrated compressed spring 396b is disposed in the periphery of the plunger 396a. When the operator is not pulling the trigger part 397, the convex part 397a is caused to abut an inner wall of the protruding part 392d by the repulsive force of the compressed spring 396b. This abutting position is the position at which the motor is stopped. Also in the fourth embodiment, the speed of the motor 304 can be adjusted by the pulling amount of the trigger part 397, and the easy-to-use foldable-type power tool can be achieved. The cover 315 is axially supported to the rear housing 302 by the turning shaft 316. However, as is understood from FIG. 21, the rearmost end position of the cover 315 and the front end position of the trigger part 397 are not overlapped with each other in the axial direction; therefore, the attachment structure of the trigger part 397 has some allowance. When the housing is folded, the cover 315 is housed in the housing space 317 of the front housing 303; therefore, space efficiency is good.

### Seventh Embodiment

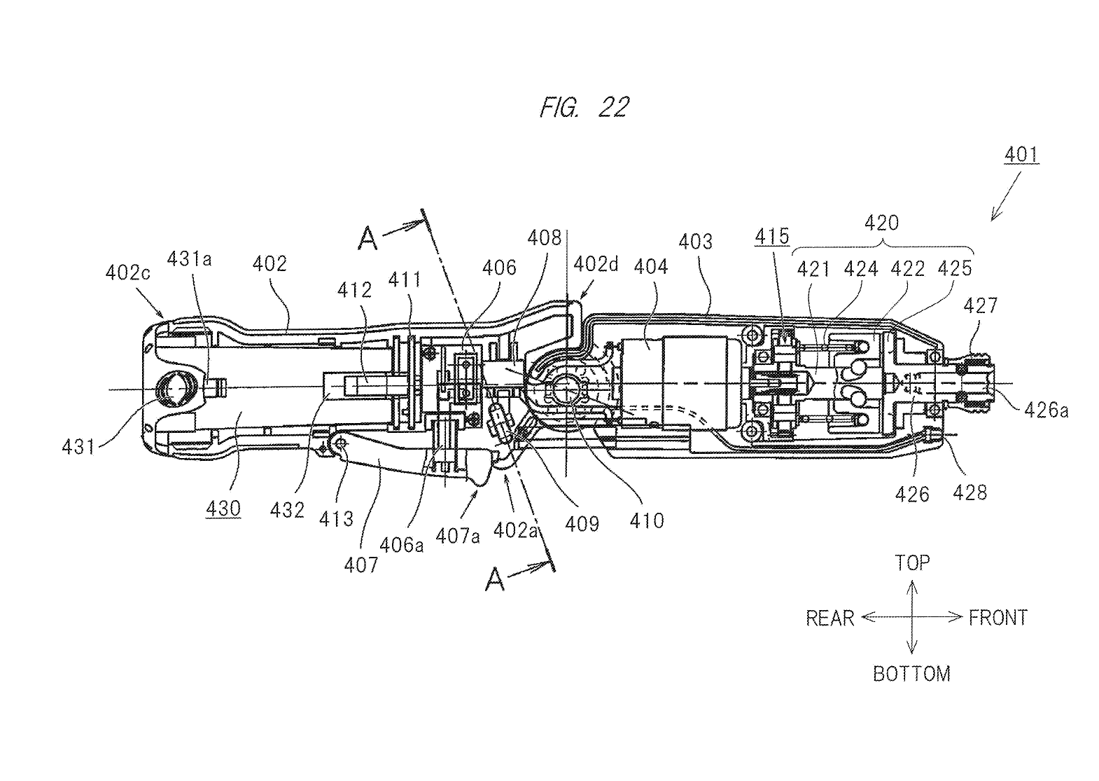

Next, a seventh embodiment will be described with reference to FIG. 22. A power tool 401 uses a chargeable battery pack 430 as an electric power source, uses a motor 404 as a drive source to apply rotative force and striking force to an output shaft 426 via a power transmission system, and intermittently transmits the rotative striking force to an unillustrated tip tool such as a driver bit retained by an attachment hole 426a covered with a sleeve 427, thereby carrying out an operation of screw tightening, bolt tightening, etc. A housing of the power tool 401 is comprised of a front housing 403 and a rear housing 402. The front housing 403 is formed by molding of a synthetic resin such as plastic so as to be dividable into two to the left and the right, and the left-right parts are fixed by unillustrated screws. An LED 428 for irradiating a tip tool, a tightened material, etc. is provided below the sleeve 427 of the front housing 403.

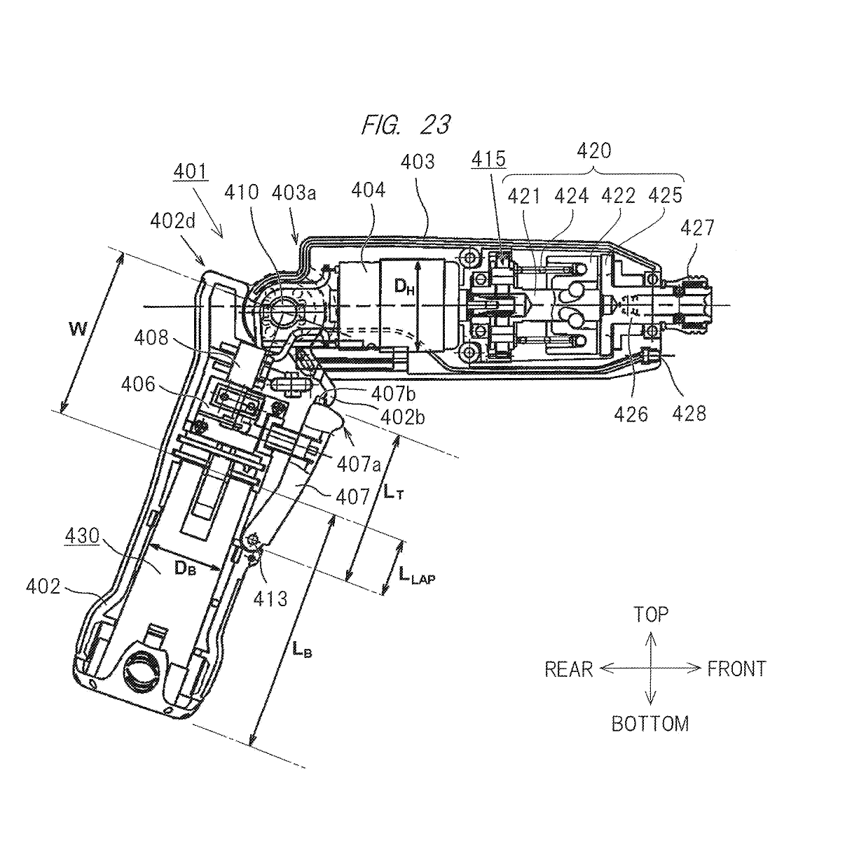

The rear housing 402 is formed to have a cylindrical shape having an opening 402c in the rear end thereof and is manufactured by integral molding of a polymer resin product such as plastic. The front housing 403 and the rear housing 402 are coupled to each other by a turning shaft 410 and are turnable about the turning shaft 410 by about 70 degrees. The plane that turns is the plane including the front-rear and top-bottom directions viewed in FIG. 22 (the plane same as the paper surface), and the shape of the so-called straight type in which the rear housing 402 and the front housing 403 are aligned on the same axis in the manner shown in FIG. 22 can be changed into the shape turned in the manner as shown in later-described FIG. 23, i.e., into the shape of a so-called gun type. An operator can set either the straight-type or gun-type shape depending on the location or target of an operation to carry out the operation.

The motor 404 is a brushed DC motor used as a drive source for rotating an unillustrated tip tool and is housed in the rear side of the front housing 403. In the present embodiment, the battery pack 430 is used as an electric power source for driving the motor 404. A rotation shaft of the motor 404 is connected to a power transmission system for rotating the tip tool. In the present embodiment, the power transmission system is comprised of: a speed reducing mechanism 415, which uses planetary wheels; and a striking mechanism 420 having a hammer 422 and an anvil 425, and they are serially disposed to have the same axis with the motor 404. The speed reducing mechanism 415 has a sun gear attached to the rotation shaft of the motor 404, a plurality of planetary gears, and a fixed-type ring gear on the outer peripheral side of the planetary gears. In the speed reducing mechanism 415, a planetary carrier fixing a rotation shaft of the plurality of planetary gears is rotated. A widely used publicly-known striking mechanism (impact mechanism) can be used to constitute the striking mechanism 420. The striking mechanism 420 is comprised of: a spindle 421, which is connected to the planetary carrier; a hammer 422, which is movable in an axial direction; a spring 424, which biases the hammer 422; cam grooves; balls; etc.

The battery pack 430 has a substantially cylindrical chassis, which is attachable and detachable to/from internal space through the opening 402c of the end part of the rear housing 402, and the battery pack is an electric power source which is a so-called cassette type and easily replaceable. Unillustrated hooking parts are provided at two locations on the chassis of the battery pack 430, and, when they are engaged with recessed parts (not illustrated) formed on the inner wall of the rear housing 402, the battery pack 430 is retained. In order to detach the battery pack 430, the battery pack 430 is pulled from the opening 402c while pressing latch parts 431 provided at two locations on the left and the right. The shape of the rear end part of the battery pack 430 is formed so as to cover the opening 402c of the rear housing 402, and the rear surface of the battery pack 430 forms part of an outer edge part of the rear housing 402. A connector 432 is provided at a substantially rectangular corner part of the front end of the battery pack 430, and a plurality of metal-made connectors 432 are fixed to a base 411 of the rear housing 402. When the battery pack 430 is attached to the interior of the rear housing 402, the connector 432 is brought into contact with the plurality of terminals 412 on the power tool 401 side; as a result, a state in which electric power from the battery pack 430 can be supplied to the motor 404 is obtained.

In the space which is in the rear housing 402 and is between the battery pack 430 and the turning shaft 410, a switch (main switch) 406, which controls supply/stoppage of electric power to the motor 404, and a forward/reverse switch 408 for switching the rotation direction of the motor 404 are housed. In the present embodiment, the switch 406 is a so-called variable resistance switch in which the resistance value thereof is varied depending on the operation amount of a plunger 406a, and the rotation speed of the motor 404 is varied depending on the operation amount of the switch 406. The plunger 406a of the switch 406 is operated by a trigger part 407 of a so-called paddle type, having a part thereof connected to the plunger 406a is slid in the top-bottom direction.

A trigger part 407 has a predetermined length in the front-rear direction, and the part thereof in contact with the plunger 406a is slidable in the top-bottom direction when the rear side of the trigger part is swung (turned) about a swinging shaft (turn supporting point) 413 by a predetermined angle. In the present embodiment, the trigger part 407 is comparatively large in the front-rear direction; therefore, the power tool 401 having an easy-to-use switch mechanism which can be easily gripped by the operator who grips the rear housing 402, which also serves as a grip part is achieved. A tip part of the trigger part 407 can be easily held by the operator and is provided with a protruding part 407a which is projecting downward so that the tip part of the trigger part 407 can be determined by a touch sensation. As the pull load (=the compression load of the plunger 406a) of the trigger part 407, initial load P may be set as shown by the expressions below, where the total weight of the rear housing 402 side (including the battery pack) is M2, and the weight of the front housing 403 side is M1.

If M2>M1,

P≧(M1+M2)/2 (1)

If M2≦M1,

P≧(M1+M2) (2)

When the pull load of the trigger part 407 is set in this manner, even if the own weight of the power tool 401 is applied to the trigger part 407 for some reason such as a situation in which the power tool 401 is placed on the floor, the switch 406 can be effectively prevented from being unintentionally turned on since the pull load of the trigger part 407 is larger than the own weight of the power tool 401.

The forward/reverse switch 408 is provided in the space which is on the front side of the switch 406 and between the switch 406 and the turning shaft 410. The forward/reverse switch 408 is a switch for switching the rotation direction of the motor 404 to a “forward rotation direction (tightening direction)” and a “reverse rotation direction (loosening direction)”. The forward/reverse switch 408 can be operated by sliding an operation lever 409 in the left-right direction; however, a lock mechanism is preferred to be achieved such that the operation lever 409 is provided not only with two locations, i.e., a forward-rotation-direction position and a reverse-rotation-direction position but also with a lock position therebetween so that, when the operation lever 409 is fixed at the position, the trigger part 407 is mechanically locked to disable pulling or the motor 404 is not electrically turned on.

FIG. 23 is a vertical cross-sectional view of the power tool 401, in which the rear housing 402 and the front housing 403 are relatively turned from the state of FIG. 22 to obtain the state of a so-called gun type. As is understood from FIG. 23, the trigger part 407 is provided so as to be overlapped with the battery pack 430 when viewed in the axial direction of the rear housing 402. More specifically, in the axial-direction length from the turning shaft 410 to the rear end part of the rear housing 402, the length occupied by the battery pack 430 is L_{B}, and the length occupied by the trigger part 407 is L_{T}. According to FIG. 23, it can be understood that the battery pack 430 and the trigger part 407 are overlapped with each other by a distance L_{LAP} when viewed in the axial direction of the rear housing 402.

The swinging shaft 413 is disposed in the overlapped part. Therefore, even when the axial-direction length of the space between the battery pack 430 and the turning shaft 410 is limited, the length of the trigger part 7 can be configured to be sufficiently long, and the axial-direction length of the rear housing 402 is effectively prevented from being increased depending on the shape of the trigger part 407. In the front housing 403, the switch mechanism is not required to be housed between the motor 404 and the turning shaft 410 different from the conventional technique described in Patent Document 1. Therefore, the axial-direction length of the front-side housing 403 can be made shorter by the length of the switch mechanism. Herein, the outer diameter DB of the battery pack 430 is 18 mm, and the diameter DH of the motor 404 is 29 mm, where the outer diameter DB of the battery pack 430 is made sufficiently small with respect to the motor. Therefore, sufficient space can be ensured at the lower side of the battery pack 430 side, the grip part can be prevented from becoming thick even when the trigger part 407 of the paddle type is provided, and therefore the easy-to-hold power tool can be achieved. The motor and the turning mechanism are disposed on the same axis inside the front housing, and a rear end of the motor is adjacent to the turning mechanism.

The axial direction of the swinging shaft 413 is disposed so as to be in the left-right direction of the rear housing 402. This is a perpendicular direction when viewed from the turning plane. On the inner side of the vicinity of the front end of the trigger part 407, a convex part 407b, which abuts the inner side of a stopper wall 402b of the rear housing 402, is formed. Part of the switch-side surface of the trigger part 407 abuts the plunger 406a. The plunger 406a is biased by an unillustrated compression spring in the direction in which the plunger 406a projects from the switch 406. When the operator stops holding the trigger part 407, the convex part 407b is returned by the effect of the spring to the position abutting the stopper wall 402b, i.e., to the position at which the motor 404 is turned off.

In the present embodiment, in the internal space of the rear housing 402, the two switches, i.e., the switch 406 and the forward/reverse switch 408 are disposed between the front end surface of the battery pack 430 and the turning shaft 410. In the present embodiment, these two switches are mutually different parts; however, a switch unit for a power tool of a combination type in which they are integrated may be used. A front upper end part of the rear housing 402 serves as a protruding part 402d, which abuts a step part 403a of a rear part of the front housing 403 and serves as a stopper in the straight state.

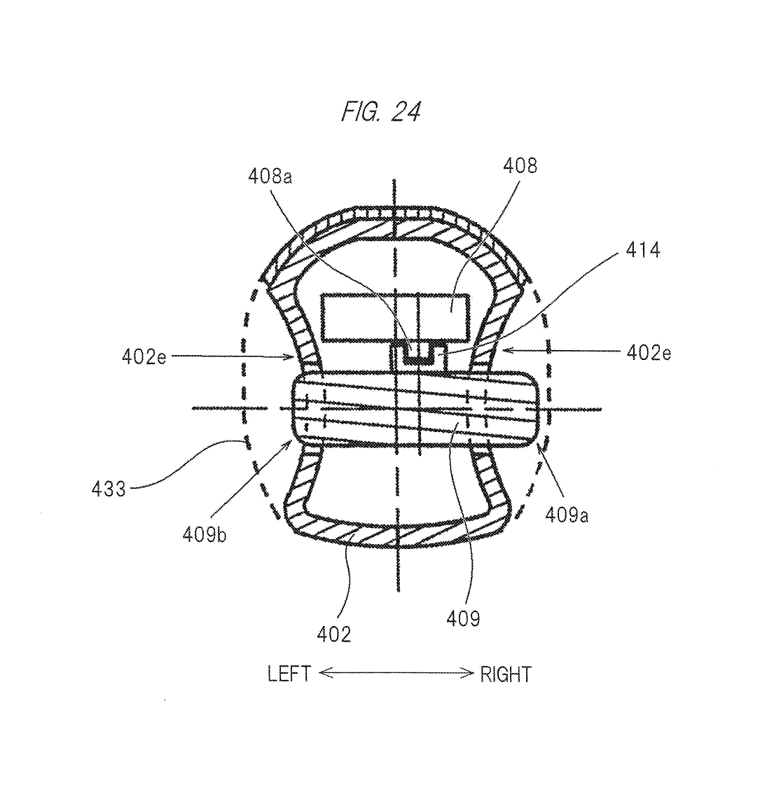

FIG. 24 is a cross-sectional view of the A-A part of FIG. 22. In the present embodiment, the shape of the rear housing 402 is as shown by an outer line 433 shown by a dotted line; meanwhile, when the operation lever 409, which operates the forward/reverse switch 408, is moved in the left-right direction, a right end 409a or a left end 409b thereof is configured so as not to project to the outer side in the radial direction beyond the outer line 433 having a substantially circular shape. Therefore, on the both left and right sides of the rear housing 402, concave parts 402e are formed around the vicinity of the operation lever 409 so that the protruding part of the operation lever 409 is positioned within the concave part 402e.

When the plunger 408a is moved in the left-right direction, the forward/reverse switch 408 switches the rotation direction of the motor 404 to forward rotation or reverse rotation. The plunger 408a is linked with the movement of the operation lever 409 and moved to the left-right by a working part 414 fixed to the operation lever 409. When the operation lever 409 is disposed in this manner, in a situation in which the power tool 401 particularly having the shape of the straight type is placed and rolled on the floor or the like, the operation lever 409 can be effectively prevented from being moved by the own weight of the power tool 401. In the seventh embodiment of FIG. 24, the concaves 402e are formed to be comparatively large as compared with the outer line 433. However, the degree of formation of the concaves 402e is optional, and another arbitrary shape may be used as long as the operation lever 409 is not moved when the main body is rolled.

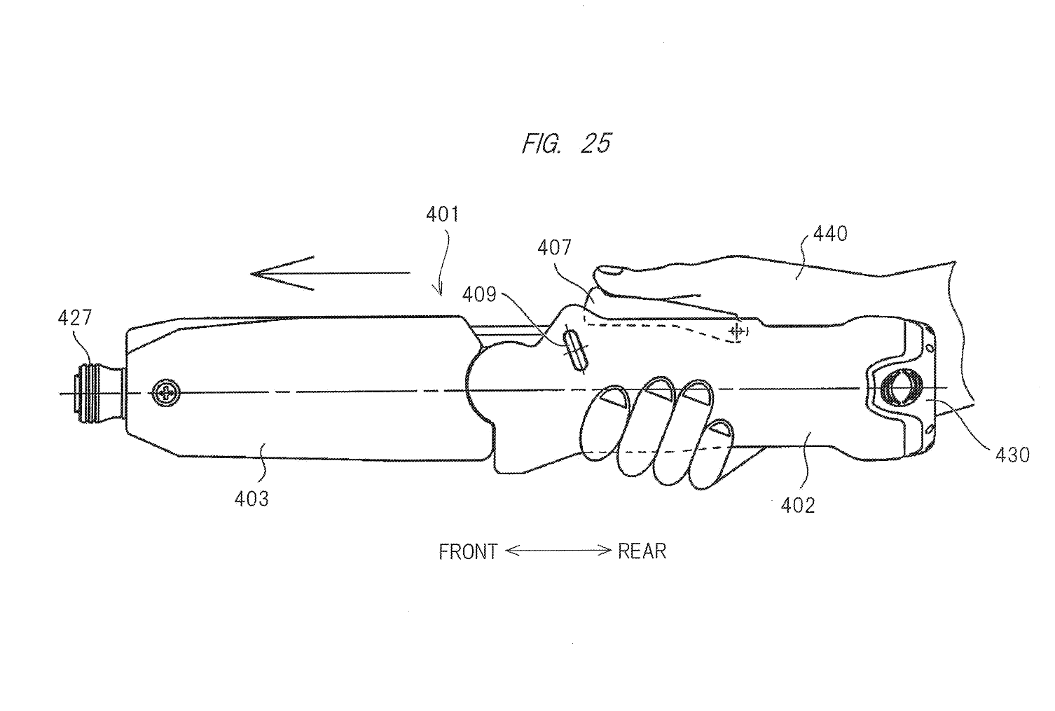

Next, with reference to FIGS. 25 to 27, the states upon operation of the power tool 401 of the present embodiment will be described. FIG. 25 is a diagram showing a usage state in the straight state of the power tool 401. In the straight state, the operator uses the power tool 401 by gripping the rear housing 402 and actually applying pressing force in the direction of an arrow in the drawing. In this process, the operator can operate the trigger part 407 with the thumb while gripping the grip part having a somewhat narrowed diameter of the rear housing 402. The operation lever 409 for switching the rotation direction of the motor is disposed in the vicinity of the thumb; therefore, the operation lever 409 can be easily operated by slightly moving the thumb or the forefinger, and the very easy-to-use foldable-type power tool 401 can be achieved.

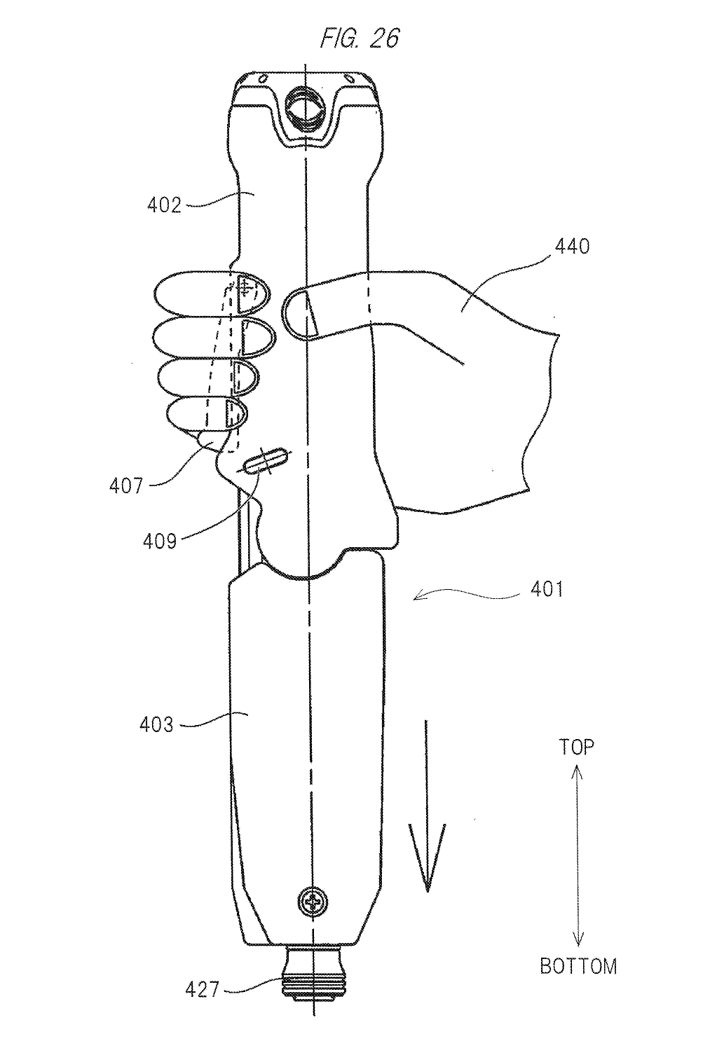

FIG. 26 is a diagram showing a usage state in the straight state of the power tool 401 and showing the state in which the power tool 401 is caused to face downward to carry out an operation. In the situation in which the power tool 401 is caused to face downward, the way of gripping by a hand 440 of the operator is often that shown in the drawing, and, in this case, the trigger part 407 is operated by the part from the forefinger to the little finger instead of the thumb. Even in use in such a gripping state, the trigger part 407 is longer in the longitudinal direction and therefore can be easily operated, and a tightening operation can be effectively carried out while optionally adjusting the rotation speed of the motor 404. Even in the case of such a gripping manner, the operation lever 409 for forward/reverse switching is immediately below the hand and therefore can be easily operated.

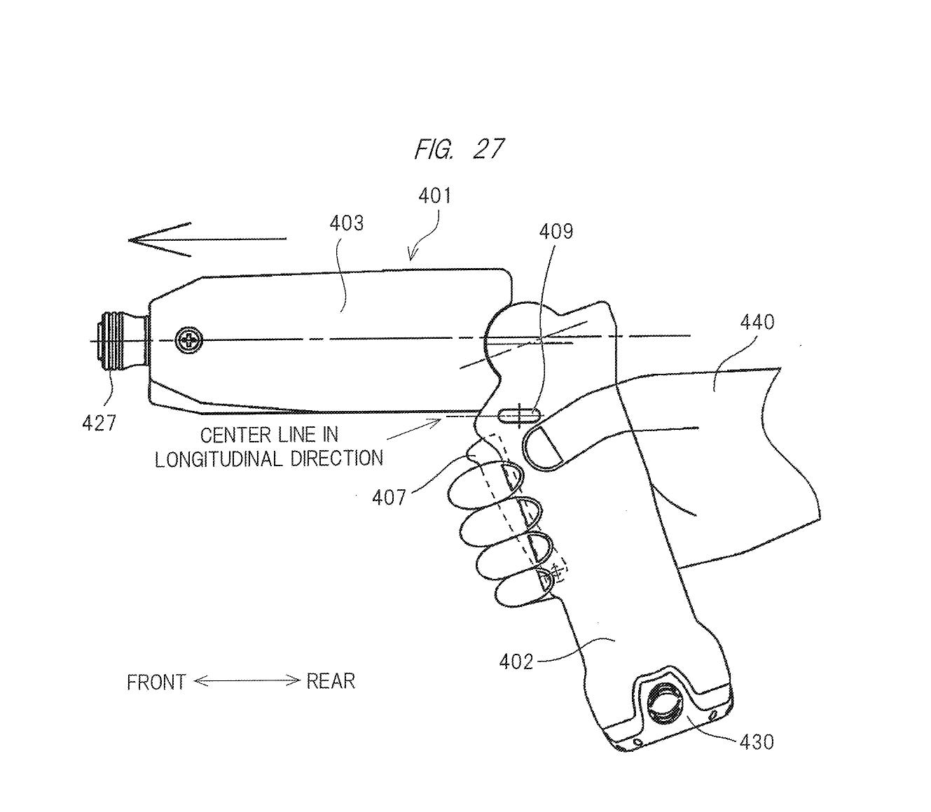

FIG. 27 is a lateral view for explaining a usage state in the folded state of the power tool 401 and also is a diagram showing a state in which an operation is carried out in the aspect of the so-called gun type. In this state, pressing force is applied in the direction of an arrow in FIG. 27 to use the power tool 401. Therefore, the operation is carried out by the way of gripping as shown in the drawing as well as operation with a normal impact driver. In this process, the operator operates the trigger part 407 by the part from the forefinger to the little finger. The trigger part 407 may be operated only with the forefinger by gripping a slightly lower side of the rear housing 402. Upon gripping in this manner, the operation lever 409 is positioned immediately above the thumb; therefore, the gripping state is not required to be largely changed, and the operation lever 409 can be easily moved only by moving the thumb or the little finger. The operation lever 409 has a corner-rounded oblong shape in a lateral view, and the center line thereof in the longitudinal direction is disposed so as to be parallel to the axis line from the motor 404 to the tip tool. Therefore, the operation lever 409 which is very easy to use when operation is carried out in the gun-type shape as shown in FIG. 27 can be achieved. FIGS. 25 to 27 show the case in which the hand of the operator is small. However, also in the case of an operator having a large hand size, similar effects are obtained.

As described above, in the three states of FIGS. 25 to 27, the way of gripping of the grip part differs; however, in any of the cases, the power tool which is small, causes the trigger part 407 of the switch 406 to fit the hand, and have easy-to-operate specifications (layout and shape) is achieved. When the shape (length direction) of the trigger part 407 of the switch 406 is to be determined, the large trigger part 407 which is easy to be operated by the user can be used, and the shape can be set without being limited by the disposing position of the battery pack 430, which serves as an electric power source. Furthermore, the overlapping amount L_{LAP} of the trigger part 407 of the switch 406 and the battery pack 430 is maximally reserved; therefore, the axial-direction length of the grip part can be shortened, the total length can be shortened in the straight state, the total height can be shortened in the gun-type state, and thus the compact power tool can be achieved.

### Eighth Embodiment

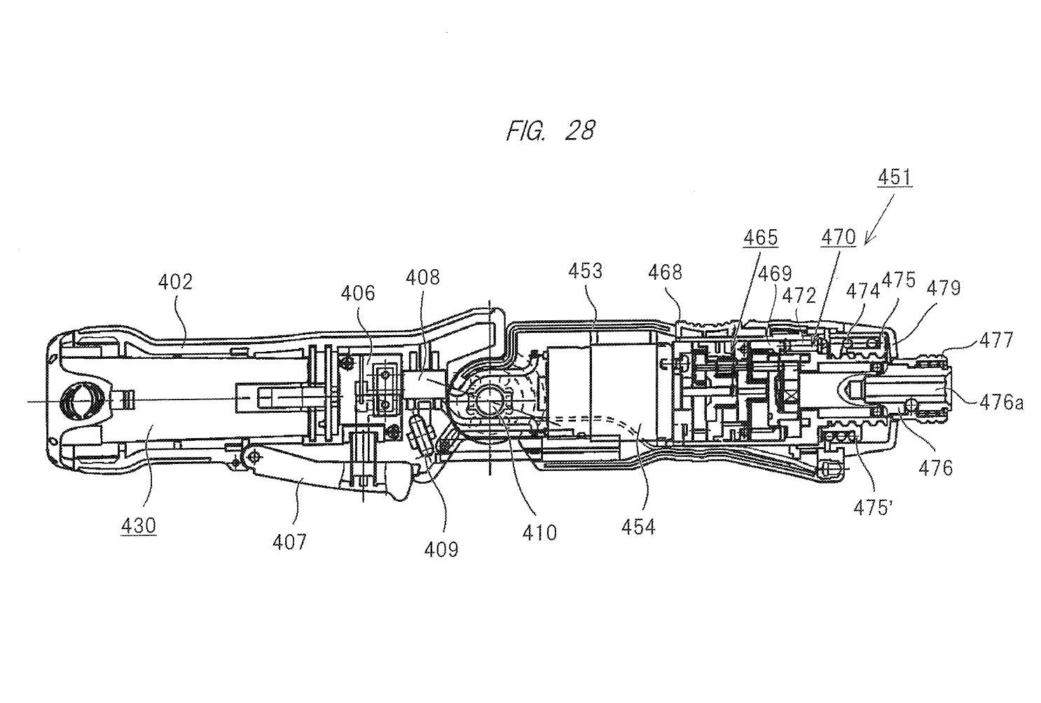

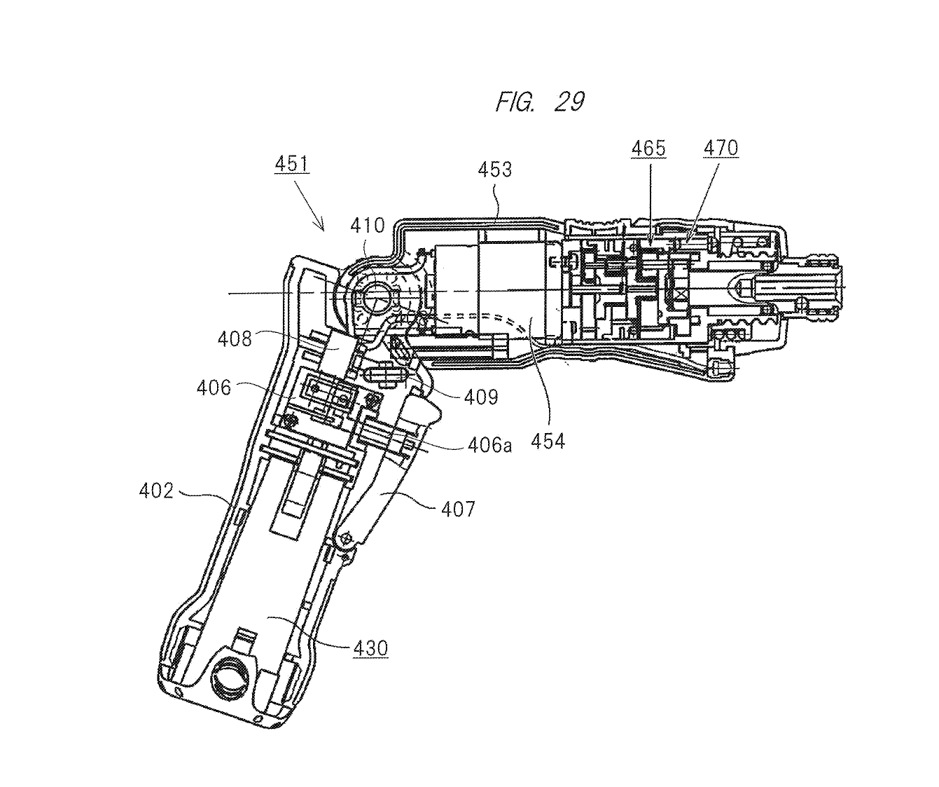

Next, an eighth embodiment of the present invention will be described with reference to FIGS. 28 and 29. FIG. 28 is a vertical cross-sectional view showing an overall structure of a foldable power tool 451 (driver drill) according to the eighth embodiment of the present invention and also is a diagram showing the straight state. In the power tool 451, the internal structure of the rear housing 402 and the battery pack 430 have the same structures as those of the power tool 401 described in the seventh embodiment. In the eighth embodiment, the structure of a front housing 453 side is different, and a speed reducing mechanism 465 and a clutch mechanism 470 are contained as a power transmission system.

The power tool 451 utilizes the electric power, which is supplied by the battery pack 430, to rotate the motor 454 serving as a drive source. The rotation of the motor 454 is subjected to speed reduction by the speed reducing mechanism 465 and subjects an output shaft 476 to rotary drive at a predetermined speed via the clutch mechanism 470. The speed reducing mechanism 465 is comprised of, for example, a three-level planetary-wheel speed-reducing mechanism (speed-changing gear case) meshed with a pinion gear of a rotation shaft of the motor 454. Moreover, the speed reducing mechanism 465 has a shift knob 468 for switching a speed switching ratio, and two-level speed change to a low speed and a high speed is enabled when the operator carries out a switching operation of the shift knob 468. A housing of the power tool 451 is comprised of the front housing 453 and the rear housing 402. The front housing 453 and the rear housing 402 are turnable about the turning shaft 410 by about 70 degrees only; and operations can be carried out in a so-called straight-type shape in which the front housing 453 and the rear housing 402 have the same axis with each other as shown in FIG. 28 and in a so-called gun-type shape in which the state of FIG. 28 has been turned about the turning shaft 410 (described later with FIG. 29). The front housing 453 is configured to be dividable into two to the left and the right by molding of a synthetic resin such as plastic, and the left-right parts are fixed by unillustrated screws.

The clutch mechanism 470, which is disposed on the tip side of the front housing 453, controls whether rotation torque, which is obtained at the output shaft of the speed reducing mechanism 465, is to be transmitted to the output shaft 476 or not in response to load. In this manner, when desired tightening torque (load torque) is set in advance by a dial 479 for torque adjustment and mode switching, the clutch mechanism 470 has a function that, when the rotative force of the output shaft of the speed reducing mechanism 465 reaches the set tightening torque, the output shaft is caused to idle to shut off the transmission of rotation from the speed reducing mechanism 465 to the output shaft 476.

The clutch mechanism 470 is comprised of: a pin 472, which is a clutch nail; a clutch nail, which is formed on a front end surface of a ring gear 469 constituting the third-level planetary-gear speed-reducing mechanism; a coil spring 474, which presses the pin 472 toward the rear in the axial direction; and a pressing member 475, which is movable in the axial direction on the front side of the coil spring 474. The pressing member 475 is configured so as to be rotated in synchronization when the dial 479 is rotated. When the dial 479 is operated to be rotated, the pressing member 475 is moved in the axial direction. When the pressing member 475 is moved in the axial direction (front-rear direction), the strength of the biasing force of the pin 472 toward the rear can be adjusted, and the tightening torque (load torque) can be adjusted.

In FIG. 28, a cross-sectional view of the pressing member 475 at a foremost position is shown above the output shaft 476, and a cross-sectional view of a pressing member 475′ at a rearmost position is shown below the output shaft 476; however, they are shown to be virtually vertically asymmetrical in order to facilitate understanding. 475 denotes the state before the dial is turned where the coil spring 474 is stretched the most, and 475′ denotes the state after the dial 479 is turned where the coil spring 474 is compressed. The pressing member 475 is a ring-shaped member continued in the circumferential direction; therefore, in practice, the pressing member has a vertically symmetrical shape.

FIG. 29 is a vertical cross-sectional view showing the overall structure of the foldable power tool 451 (driver drill) according to the eighth embodiment of the present invention and also is a diagram showing a folded state. In the present embodiment, the switch is not disposed between the motor 454 and the turning shaft 410 different from the technique of Patent Document 1 which is a conventional technique. Therefore, the front housing 453 of the folded-type driver drill of which total length tends to be long when the clutch mechanism 470 is contained can be configured to be short. Also in the eighth embodiment, operability equivalent to that explained in FIGS. 25 to 27 can be achieved, and the folded-type power tool which is compact and easy to use can be achieved.

### Ninth Embodiment

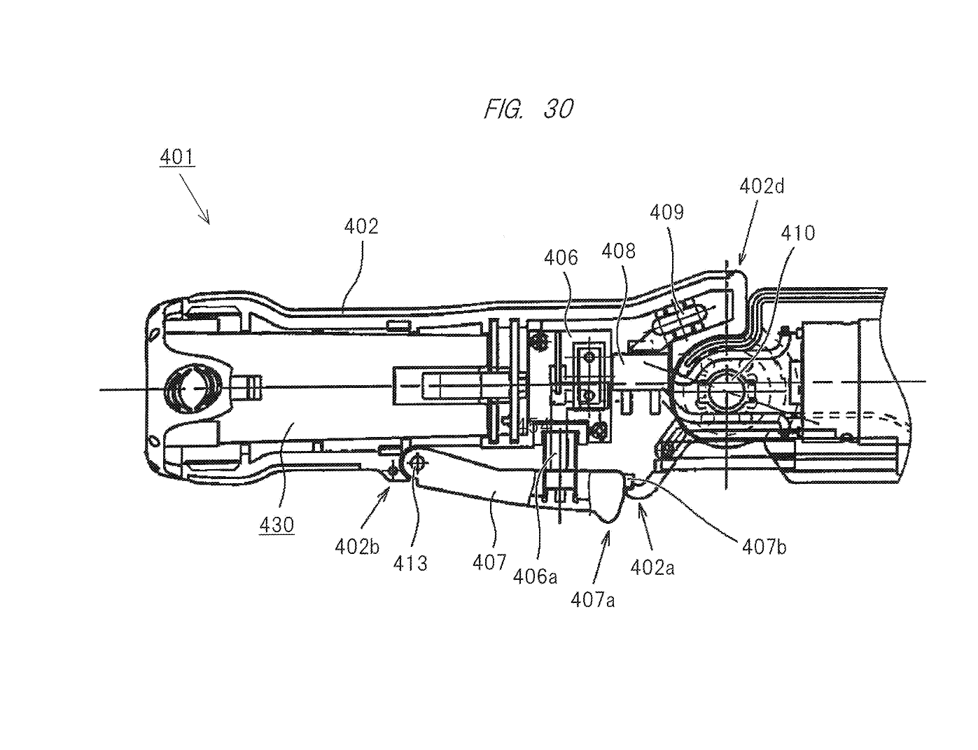

Next, a ninth embodiment of the present invention will be described with reference to FIG. 30. FIG. 30 is a partial cross-sectional view of a power tool 451, wherein, although the configurations of the switch 406 and the trigger part 407 are the same with the eighth embodiment, the attachment positions of the forward/reverse switch 408 and the operation lever 409 thereof are different. In the front upper side of the rear housing 402, the protruding part 402d, which serves as a stopper in the case of a straight shape, is formed. Since the space which is not used is present in the protruding part 402d, the operation lever 409 is disposed in the space. When the operation lever 409 is provided in the space, the operating feeling is different from that of the operation lever 409 in FIGS. 25 to 27; however, better operations than those of the conventional technique described in Patent Document 1 can be achieved.

### Tenth Embodiment

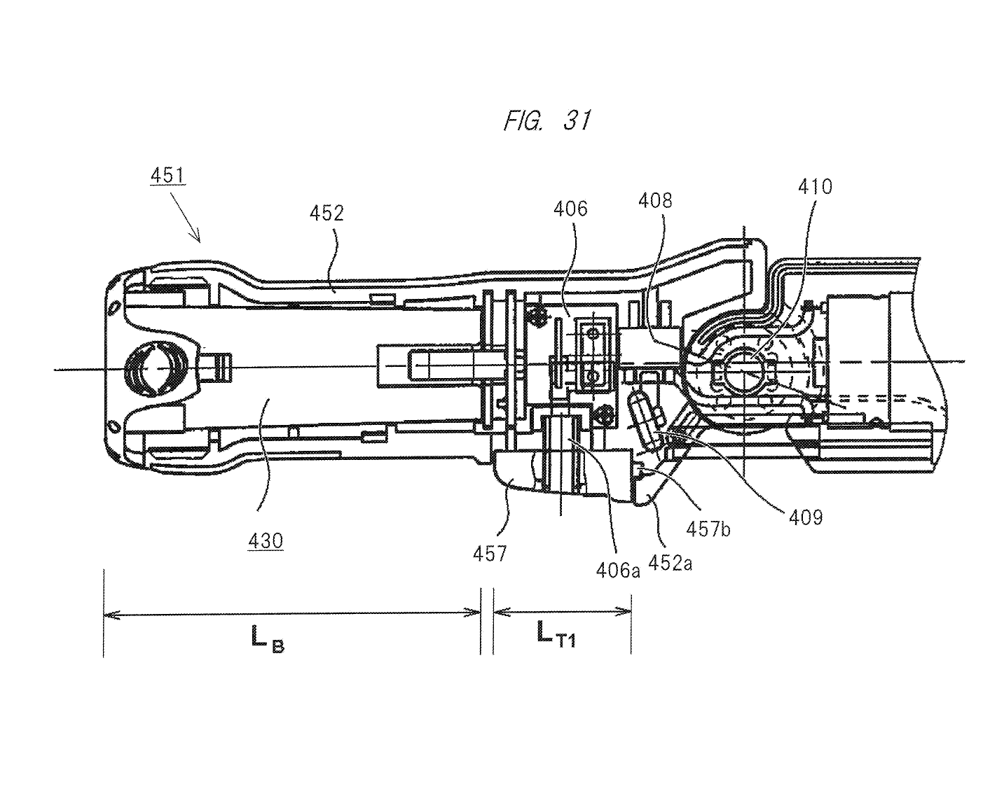

Next, a tenth embodiment of the present invention will be described with reference to FIG. 31. FIG. 31 is a partial cross-sectional view of the power tool 451, where the configurations of the switch 406, the forward/reverse switch 408, and the operation lever 409 are the same as those of the seventh embodiment. However, the configuration and the shape of a trigger part 457 are different. Instead of a paddle-type switch, the trigger part is configured to have the same shape as that of a trigger operation part which is used in, for example, a widely-used impact driver or a driver drill. The switch 406 connected to the trigger part 457 can use the same part as the ninth embodiment, and the rotation speed of the motor can be adjusted by siding and moving the plunger 406a in the top-bottom direction by the trigger part 407. The front-rear-direction length L_{T1} of the trigger part 457 of the tenth embodiment is comparatively short and has a size which is suitable for the operator to carry out a pulling operation with the forefinger or the thumb. Moreover, the trigger part is configured so as not to be overlapped in the axial direction with the length L_{B} in which the battery pack is housed; therefore, the switch mechanism which is comparatively simple can be achieved, and reduction of cost can be effectively implemented.

At the front-side part of the rear housing 452 in which the trigger part 457 is provided, a protruding part 452a protruding downward than the trigger part 457 is formed and plays a role of a stopper so that, when the operator places the power tool 451 in the straight state on the floor, the trigger part 457 is not unintentionally caused to be in a pulled state. An unillustrated compressed spring is disposed in the periphery of the plunger 406a. When the operator is not pulling the trigger part 457, a convex part 457b of the trigger part 457 is caused to abut the inner wall of the protruding part 452a by the repulsive force of the compression spring. This abutting position is the position at which the motor is stopped.

### Eleventh Embodiment

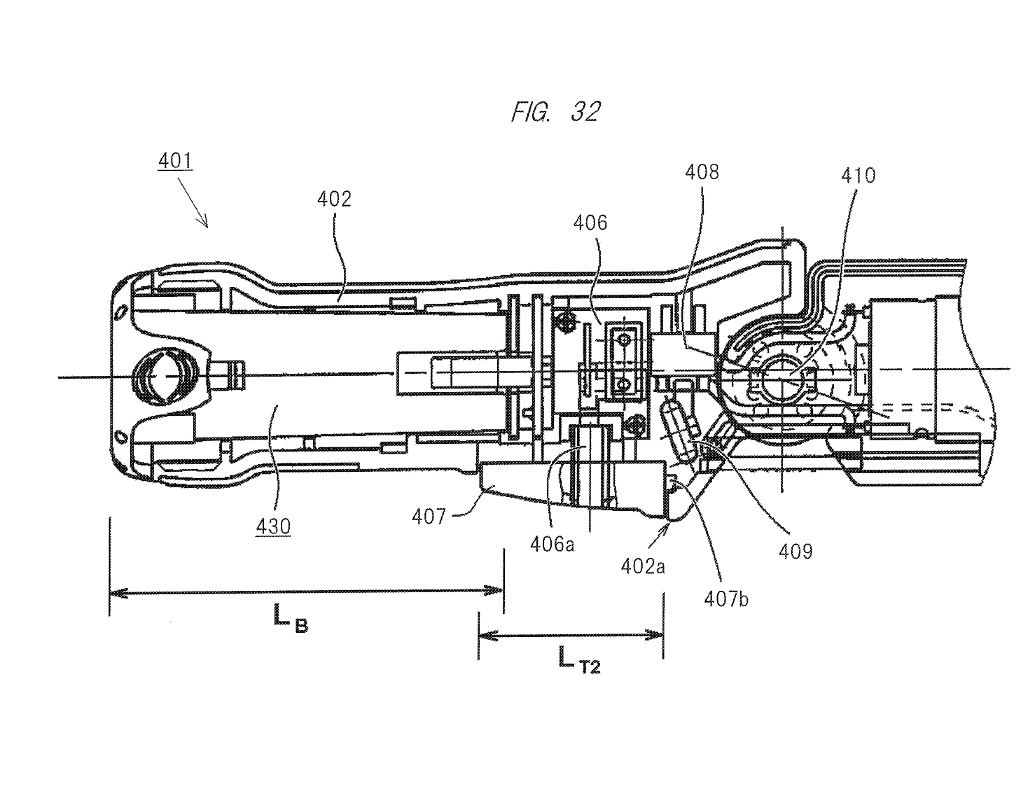

Next, an eleventh embodiment of the present invention will be described with reference to FIG. 32. FIG. 32 is a partial cross-sectional view of the power tool 401, where the configurations of the switch 406, the forward/reverse switch 408, and the operation lever 409 are the same as those of the tenth embodiment. However, the configuration of the trigger part 407 is different, and, compared with the trigger part 407 shown in FIG. 31, the trigger part is formed to be somewhat long in the front-rear direction although the structure thereof is the same, which is not the paddle type for example. As the switch 406 connected to the trigger part 407, the same part as that of the seventh embodiment can be used; and the rotation speed of the motor can be adjusted by slide-moving the plunger 406a in the top-bottom direction by the trigger part 407.

The front-rear-direction length L_{T2} of the trigger part 407 of the eleventh embodiment is short compared with L_{T} of the seventh embodiment and has a size suitable for the operator to carry out a pulling operation with the forefinger and the middle finger. Moreover, the trigger part 407 is configured so as to be slightly overlapped in the axial direction with the length L_{B} in which the battery pack is housed; therefore, the trigger part 407, which is somewhat long, can be achieved without increasing the total length of the rear housing 402. In the front-side part of the rear housing 402 in which the trigger part 407 is provided, a protruding part 402a, which protrudes more downward than the trigger part 407, is formed. When the operator places the power tool 401 in the straight shape on the floor, the protruding part plays a role as a stopper so that the trigger part 407 is not unintentionally caused to be in a pulled state. An unillustrated compression spring is disposed in the periphery of the plunger 406a. When the operator is not pulling the trigger part 407, the convex part 407b of the trigger part 407 is caused to abut the inner wall of the protruding part 402a by the repulsive force of the compression spring. This abutting position is the position at which the motor is stopped.

### Twelfth Embodiment

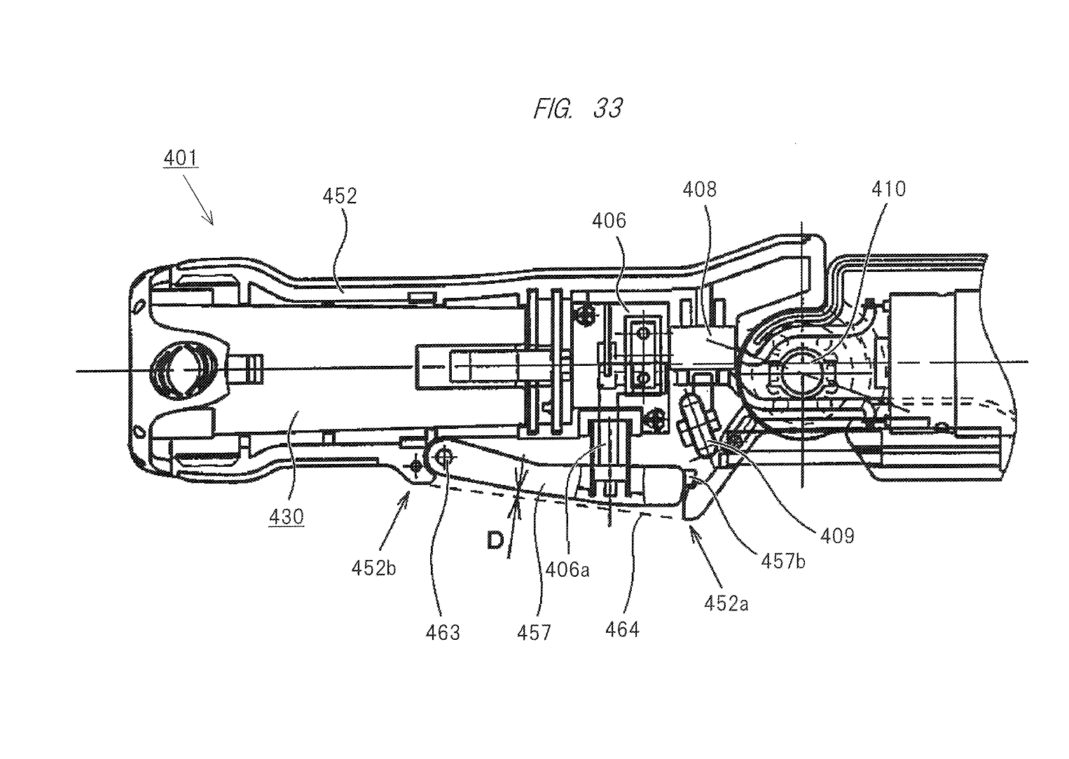

Next, a twelfth embodiment of the present invention will be described with reference to FIG. 33. FIG. 33 is a partial cross-sectional view of the power tool 451; where the configurations of the switch 406, the forward/reverse switch 408, and the operation lever 409 are the same as those of the seventh embodiment. An improved point of the present embodiment is that a switch structure of the paddle type is used to prevent the trigger part 457 from being erroneously caused to be in a pulled state and from rotating the motor when the operator places the power tool 451 on the floor. Therefore, the trigger part 457 and the shape of the housing 452 which is in the vicinity thereof are improved. In the housing 452, a protruding part 452b, which protrudes downward, is formed to the rear of a swinging shaft 463, and the protruding part 452a, which is protruding downward, is formed in the front side of the trigger part 457. In this case, a virtual straight line (dotted line 464) mutually connecting the protruding part 452a and the protruding part 452b and the lower edge of the trigger part 457 are configured to ensure at least a distance D therebetween. As a result of the configuration in this manner, when the operator places the power tool 451 in the straight shape on the floor, the trigger part 457 can be effectively prevented from being caused to be in a pulled state as a result of contact with a floor surface, and the power tool with further enhanced safety can be achieved.

Hereinabove, the present invention has been explained based on the plurality of embodiments. In any of the cases, the disposing methods of the switches of the power tools thereof can simultaneously achieve downsizing in addition to improvement in the switch operability, and the operability can be genuinely improved.

Hereinabove, the present invention has been explained based on the embodiments. However, the present invention is not limited to the above-described embodiments, and various modifications can be made within the range not departing from the gist thereof. For example, the above-described embodiments are formed by using the attachable/detachable battery pack 430; however, the invention may be applied not only to the attachable/detachable configuration, but also to a power tool directly incorporating a battery cell in the rear housing. Moreover, the power transmission system housed in the front housing of the foldable-type power tool can be used not only to a product comprised of the impact mechanism or the clutch mechanism, but can be similarly used also to a foldable-type power tool using another optional mechanism(s). Furthermore, the type of the motor housed in the front housing is not limited only to a brushed motor, but may be configured to use a brushless DC motor.

What is claimed is:

1. A power tool comprising:
a handle housing that houses a battery and has a first grip part;
a motor that is driven by electric power of the battery;
an output shaft to which a tip tool is attached;
a power transmission system that transmits rotative force of the motor to the output shaft;
a main housing that houses the motor and the power transmission system and has a second grip part; and
a turning mechanism that turnably connects a rear end part of the main housing to a front end part of the handle housing,
the power tool being operable at least in either one of a state that the main housing and the handle housing are disposed straight and a state that the main housing and the handle housing are disposed to be folded,
wherein, in the state that the handle housing is folded, the second grip part is positioned in front of the first grip part in an axial direction of the main housing.

2. The power tool according to claim 1,
wherein a switch and a trigger that control rotation of the motor are provided in the rear of the turning mechanism of the handle housing.

3. The power tool according to claim 1,
wherein the first and second grip parts are formed of a material having higher elasticity than that of the handle housing and the main housing, and
the second grip part is provided on each of left and right lateral surfaces of the main housing.

4. The power tool according to claim 3,
wherein the second grip part has a curved surface that is formed to serve as a surface curved in a direction opposite to that of an outer peripheral surface of the main housing having a substantially cylindrical shape.

5. The power tool according to claim 1,
wherein the first and second grip parts are manufactured by two-layer molding with the handle housing and the main housing.

6. The power tool according to claim 1,
wherein an upper end surface of the handle housing has a first recessed part having a length longer than the width of two fingers.

7. The power tool according to claim 6,
wherein, in the upper end surface of the handle housing, a second recessed part is formed in a vicinity of the rear of the trigger.

8. The power tool according to claim 7,
wherein, the trigger is disposed at a position immediately below the main housing in the state that the power tool is folded, and the direction of stroking of torque of the trigger is substantially parallel to the axial direction of the main housing.

9. The power tool according to claim 8,
wherein an end of the trigger is axially supported by a swinging shaft and is swung about the swinging shaft by a predetermined angle.

10. The power tool according to claim 9,
wherein the switch is a variable switch that varies the rotation speed of the motor in accordance with a pulling margin of the trigger.

11. The power tool according to claim 9,
wherein the swinging shaft is provided on a front side of the trigger, and a rear side of the trigger is swung about the swinging shaft.

12. A power tool comprising:
a motor;
an output shaft to which a tip tool is attached;
a power transmission system that transmits rotative force of the motor to the output shaft;
a front housing that houses the motor and the power transmission system;
a rear housing that houses a battery for supplying electric power to the motor and forms a grip part; and
a turning mechanism that is turnably connected at a rear end part of the front housing and a front end part of the rear housing,
the power tool being operable at least in a state that the front housing and the rear housing are disposed straight and a state that the front housing and the rear housing are disposed to be folded,
wherein a switch that controls rotation of the motor is provided to the rear housing,
a cover that covers a narrow angle part of the front housing and the rear housing is connected the rear housing so as to coordinate each other, and
housing space for allowing movement of the cover is provided in the front housing side.

13. The power tool according to claim 12,
wherein the housing space is disposed inside the front housing so as to be overlapped with the motor in an axial direction.

14. The power tool according to claim 12,
wherein a trigger part for operating the switch is disposed between the battery and the turning mechanism.

15. The power tool according to claim 12,
wherein the cover is provided so as to be axially supported by a turning shaft provided on the rear housing side.

16. The power tool according to claim 12,
wherein an end of the trigger part is axially supported by a swinging shaft and is swung about the swinging shaft by a predetermined angle.

17. The power tool according to claim 16,
wherein the switch varies the rotation speed of the motor depending on a pulling margin of the trigger part.

18. The power tool according to claim 17,
wherein a turning shaft of the turning mechanism, a turning shaft of the cover, and a swinging shaft of the trigger part are disposed mutually parallel.

19. The power tool according to claim 18,
wherein the turning shaft of the turning mechanism, the turning shaft of the cover, and the swinging shaft of the trigger part are sequentially disposed from the front to the rear.

20. The power tool according to claim 19,
wherein the trigger part is disposed in the rear of a rear end part of the cover, and
the trigger part and the cover are disposed so as not to be overlapped with each other in an axial direction.

21. The power tool according to claim 20,
wherein the swinging shaft of the trigger part is provided on a front side of the trigger part, and
a rear side of the trigger part is swung about the swinging shaft.

22. A power tool comprising:
a motor;
an output shaft to which a tip tool is attached;
a power transmission system that transmits rotative force of the motor to the output shaft;
a front housing that houses the motor and the power transmission system;
a rear housing that houses a battery for supplying electric power to the motor and forms a grip part; and
a turning mechanism that is turnably connected at a rear end part of the front housing and a front end part of the rear housing;
the power tool operable at least in a state that the front housing and the rear housing are disposed straight and a state that the front housing and the rear housing are disposed to be folded,
wherein a switch for controlling power supply from the battery to the motor is provided to the rear housing.

23. The power tool according to claim 22,
wherein the battery is a pack type that is attachable and detachable,
the rear housing has an opening for attaching and detaching the battery,
the switch is disposed between the battery and the turning mechanism, and
a trigger part for operating the switch is disposed on a lower side of the rear housing.

24. The power tool according to claim 22,
wherein front and rear positions of the trigger part are disposed so as to be overlapped with front and rear positions of the battery housed inside the rear housing.

25. The power tool according to claim 23,
wherein the switch is a variable resistance switch, and the rotation speed of the motor can be adjusted by an operation amount of the trigger part.

26. The power tool according to claim 25,
wherein the switch has a plunger that is moved in a top-bottom direction; and
the trigger part is of a paddle type, in which a swing shaft is provided on a rear end side, and a front side is swung in a top-bottom direction so as to move the plunger.

27. The power tool according to claim 26,
wherein the swing shaft has an axial direction that is in a direction orthogonal to a folding direction of a folding mechanism, and the swing shaft is provided at a position overlapped with the front and rear positions of the battery.

28. The power tool according to claim 22,
wherein the motor and the turning mechanism are disposed on the same axis inside the front housing, and
a rear end of the motor is adjacent to the turning mechanism.

29. The power tool according to claim 22, comprising
a slide-type forward/reverse switch for switching the rotation direction of the motor,
wherein the forward/reverse switch is disposed between the switch and a turning shaft, and
an operation lever of the forward/reverse switch is disposed to be protruded in a left-right direction from the rear housing.

30. The power tool according to claim 29,
wherein a part from which the operation lever of the rear housing is protruded is hollowed inward in a radial direction, and when the operation lever is operated, an end part of the operation lever is positioned more inside than an outermost position in the radial direction of the rear housing.

31. The power tool according to claim 22,
wherein a diameter D_{B} of the battery is smaller than a diameter D_{H} of the motor.

32. The power tool according to claim 22,
wherein, in a periphery of the trigger part of the rear housing, a protruding part is formed so that the trigger part is not moved by own weight of the power tool when the power tool is placed.
